(19) United States
(12) Patent Application Publication
(10) Pub. No.: US 2025/0093953 A1
(43) Pub. Date: Mar. 20, 2025

(54) DEVICE AND METHOD WITH GAZE TRACKING

(71) Applicant: SAMSUNG ELECTRONICS CO., LTD., Suwon-si (KR)

(72) Inventors: Weiming LI, Beijing (CN); SoonYong CHO, Suwon-si (KR); Lin MA, Beijing (CN); Chaoqun ZHUANG, Beijing (CN); Jingrui SONG, Beijing (CN); Qiang WANG, Beijing (CN); Young Hun SUNG, Suwon-si (KR)

(73) Assignee: SAMSUNG ELECTRONICS CO., LTD., Suwon-si (KR)

(21) Appl. No.: 18/884,996

(22) Filed: Sep. 13, 2024

(30) Foreign Application Priority Data
Sep. 15, 2023 (CN) 2023-11195870.4
Jun. 12, 2024 (KR) 10-2024-0076441

(51) Int. Cl. G06F 3/01; G06T 7/246; G06T 7/73; G06V 40/18

(52) U.S. Cl. CPC G06F 3/013; G06T 7/248; G06T 7/74; G06V 40/193; G06T 2207/30041; G06T 2207/30201

(57) ABSTRACT

An electronic device may operate a plurality of light sources, where each light source operates according to a light source code of a light source code set, each light source code being unique with respect to each other light source code, capture a glint signal corresponding to light emitted from the plurality of light sources through an event camera, obtain glint information from event data from the event camera, estimate a corneal sphere center position and an eye rotation center position based on the glint information, and determine three-dimensional (3D) gaze-related information based on the corneal sphere center position and the eye rotation center position.

### CROSS-REFERENCE TO RELATED APPLICATIONS

This application claims the benefit under 35 USC § 119 (a) of Chinese Patent Application No. 202311195870.4 filed on Sep. 15, 2023, in the China National Intellectual Property Administration, and Korean Patent Application No. 10-2024-0076441 filed on Jun. 12, 2024, in the Korean Intellectual Property Office, the entire disclosures of which are incorporated herein by reference for all purposes.

### BACKGROUND

### 1. Field

The following disclosure relates to the field of gaze tracking, and more particularly, to a method, device, electronic device, and storage medium with gaze tracking.

### 2. Description of Related Art

Gaze tracking is an important method that may be used, for example, with an augmented reality system to implement natural human-computer interaction. The results of gaze tracking may be used, for example, for applications such as human-computer interaction or gaze-based rendering in head-mounted devices, eye “pointing” and others. Due to the speed and frequency of eye movement, the gaze of a user is generally tracked at a high frequency for uses in human-computer interaction, with the aim of implementing gaze tracking with low latency and low cost. However, current three-dimensional (3D) gaze tracking methods always extract and use pupil information for gaze tracking, which requires additional hardware and software for additional calculations to obtain such pupil information, resulting in low efficiency and high cost of gaze tracking.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a gaze tracking method, performed by an electronic device, includes obtaining glint information based on capturing, using an event camera, a glint signal corresponding to light emitted from a plurality of light sources, wherein each light source operates according to a corresponding unique light source code of a light source code set, estimating a corneal sphere center position and an eye rotation center position based on the glint information, and determining three-dimensional (3D) gaze-related information based on the corneal sphere center position and the eye rotation center position.

The obtaining of the glint information may include obtaining event data by capturing the glint signal using the event camera, and obtaining one or more pieces of glint information by processing the event data, and the one or more pieces of glint information may include a glint image position, according to an image coordinate system of the event camera, of a glint corresponding to one or more of the plurality of light sources.

The obtaining of the one or more pieces of glint information may include identifying one or more binary codes respectively corresponding to one or more glints from a result of analyzing the event data, determining a binary code matching a key code of the light source code set from the identified one or more binary codes, determining a timestamp corresponding to a start bit of a bit sequence of the determined binary code, and obtaining a glint image position of a glint corresponding to a glint label mapped to the key code of the light source code set.

In a light source array including the plurality of light sources, a key bit of a light source corresponding to a key code of the light source code set and a key bit of another light source adjacent to the light source may be different.

In a light source array including the plurality of light sources, two or more light sources respectively corresponding to key codes of the light source code set may be spaced apart by a predetermined distance.

The plurality of light sources may be arranged in a circle on a same plane, and a distance between two light sources corresponding to respective key codes of the light source code set, among the plurality of light sources, may be a diameter of the circle.

The estimating may include estimating a corneal sphere center position at each moment based on the glint information at different moments, and estimating the eye rotation center position based on a distance between a reference eye rotation center and the corneal sphere center and based on estimated corneal sphere center positions at respective of the moments.

The glint information may include a glint image position, the glint image position may be a position of a glint from a corresponding light source among the plurality of light sources in an image coordinate system of the event camera, and the estimating may include estimating a corneal sphere center position at each of the moments using a regressor based on the glint image position at the moment.

The estimating of the corneal sphere center position at each moment may include transforming the glint image position at each moment from the image coordinate system of the event camera to an image coordinate system of a virtual camera, based on intrinsic parameters among parameters of the event camera, estimating the corneal sphere center position at the moment in a 3D coordinate system of the virtual camera through the regressor, from the glint image position at the corresponding moment, and transforming the corneal sphere center position at the moment from the 3D coordinate system of the virtual camera to a 3D coordinate system of the event camera.

The glint information may include a glint image position, the glint image position may be a position of a glint from a corresponding light source among the plurality of light sources in an image coordinate system of the event camera, and the estimating may include estimating a corneal sphere center position at each moment through a numerical solver based on the glint image position at the moment, the parameters of the event camera, the position of the light source, and a radius of the corneal sphere.

The estimating of the corneal sphere center position at each moment may include transforming the glint image position at each moment to a corrected image coordinate system of the event camera, based on intrinsic parameters among parameters of the event camera, transforming the position of the light source to a 3D coordinate system of the event camera, based on extrinsic parameters among the parameters of the event camera, and estimating a corneal sphere center position at each moment through the numerical solver based on the glint image position at the corresponding moment in the corrected image coordinate system, a position of the light source in the 3D coordinate system of the event camera, and the radius of the corneal sphere.

The estimating of the eye rotation center position may include estimating the eye rotation center position to be a position of a center of a rotating sphere determined based on a movement trajectory of the corneal sphere center positions at the plurality of moments.

The estimating of the eye rotation center position may include updating the eye rotation center position if a range of the movement trajectory of the corneal sphere center positions at the plurality of moments exceeds a predetermined range threshold.

The electronic device may be a head-mounted device, the gaze tracking method may further include updating a reference eye rotation center position using the estimated eye rotation center position, when movement of the head-mounted device relative to a wearer's head is detected, and the determining of the 3D gaze-related information may include determining 3D gaze-related information based on the corneal sphere center position and the updated eye rotation center position.

The updating may include updating the reference eye rotation center position using the estimated eye rotation center position, when a change in the estimated eye rotation center position exceeds a predetermined threshold.

The updating of the reference eye rotation center position may include comparing an estimated monocular eye rotation center position and a current reference monocular eye rotation center position, and updating the reference monocular eye rotation center position using the estimated monocular eye rotation center position, when a difference between the estimated monocular eye rotation center position and the reference monocular eye rotation center position exceeds a first threshold.

The updating of the reference eye rotation center position may include estimating a head pose with respect to the electronic device based on an estimated left eye rotation center position and an estimated right eye rotation center position, comparing the estimated head pose with a current reference head pose, and updating the reference head pose with the estimated head pose and updating the left eye rotation center position and the right eye rotation center position based on the updated head pose, when a difference between the estimated head pose and the reference head pose exceeds a second threshold.

The determining of the 3D gaze-related information may include determining an eye optic axis based on the corneal sphere center position and the eye rotation center position, and determining an eye visual axis as the 3D gaze-related information based on the eye optic axis and a Kappa angle between the eye optic axis and the eye visual axis.

In another general aspect, a method includes: emitting, onto an eyeball, light from light sources, wherein each light source emits light with a respective unique emission pattern of varying light intensity; detecting, asynchronously from the emitting of the light from the light sources, glints on the eyeball from the respective light sources, wherein each glint has an intensity pattern corresponding to the emission pattern of the light source from which it originates; determining, among the glints, a key glint based on the intensity pattern of the key glint; and based on the determining of the key glint, determining which of the other glints come from which of the light sources

In another general aspect, an electronic device includes a plurality of light sources, each light source operating according to a light source code of a light source code set, each light source code being unique from each other light source code, an event camera configured to capture a glint signal corresponding to light emitted from the plurality of light sources, one or more processors, and a memory storing computer-executable instructions configured to cause the one or more processors to obtain glint information based on capturing using the event camera, estimate a corneal sphere center position and an eye rotation center position based on the glint information, and determine 3D gaze-related information based on the corneal sphere center position and the eye rotation center position.

Other features and aspects will be apparent from the following detailed description, the drawings, and the claims.

### BRIEF DESCRIPTION OF THE DRAWINGS

FIG. 1 illustrates an example of a gaze tracking method, according to one or more embodiments.

FIGS. 2 and 3 illustrate an example of an operating principle of an event camera, according to one or more embodiments.

FIG. 4 illustrates an example of an optical path along which light emitted from a light source reaches an event camera via a glint, according to one or more embodiments.

FIG. 5 illustrates an example of a timing diagram of signals to control light-emitting diode (LED) light sources using an improved coding scheme, according to one or more embodiments.

FIG. 6 illustrates an example of obtaining, by an electronic device, a glint label based on a light source code set, according to one or more embodiments.

FIGS. 7 and 8 illustrate examples of estimating a corneal sphere center position, according to one or more embodiments.

FIG. 9 illustrates an example of a relationship between an eye rotation center and corneal sphere center positions at K moments, according to one or more embodiments.

FIG. 10 illustrates an example of estimating an eye rotation center position, according to one or more embodiments.

FIG. 11 illustrates an example of determining a three-dimensional (3D) gaze using a corneal sphere center position and an eye rotation center position, according to one or more embodiments.

FIGS. 12 to 14 illustrate examples of sliding detection and compensation, according to one or more embodiments.

FIG. 15 illustrates an example of a method for gaze tracking, according to one or more embodiments.

FIG. 16 illustrates an example of a device for gaze tracking, according to one or more embodiments.

FIG. 17 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

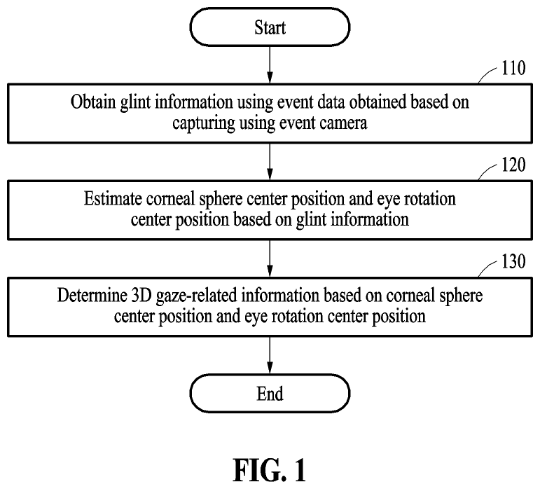

FIG. 1 illustrates an example of a gaze tracking method, according to one or more embodiments.

In operation 110, an electronic device may obtain glint information. The glint information may be information about a glint. A glint may be a point or area where light from a light source is reflected from the surface of an object. Herein, an object may be, for example, a cornea, and a cornea glint may be a point at which light is reflected from a cornea. The electronic device may obtain the glint information based on image capturing using an event camera.

The event camera may be a special camera configured based on the principle of the biological retina and may generate signals specifically (or only) for local brightness changes. The event camera may include an imaging sensor that responds to local changes in brightness. For example, the event camera may generate and/or record data in the form of an asynchronous event stream by selectively sensing only pixels showing brightness changes. Data in which an event (e.g., a brightness change in a pixel) is selectively sensed and outputted by the event camera is recorded may be referred to as event data. The event data may include, for example, the position of a pixel where an event occurs, the time when the event occurs, and/or the direction (e.g., polarity) of a brightness change.

According to an embodiment, the electronic device may capture a glint signal through the event camera. The electronic device may obtain the glint information based on the captured glint signal. For example, the event camera in the electronic device may capture a glint signal of light emitted from a light source and reflected from the surface of the cornea. The glint signal may be obtained when light emitted from a light source is reflected at a glint. When the event camera performs capturing with the support of a specifically configured light source, the event camera may capture a glint signal. The event camera may generate event data in response to the capturing of a glint signal. For example, the event data may include a brightness change event occurring in a pixel receiving the glint signal among pixels (e.g., sensing elements/cells) of the event camera. Accordingly, the event data generated by the event camera may include event information (or “events”) respectively corresponding to brightness change events. Among the pieces of event information (or events), information corresponding to a brightness change event caused by light reflected from the corneal surface of an eye (e.g., the light emitted from a light source) may be referred to as glint information. The glint information may be a position corresponding to a glint signal, and may include, for example, a pixel position where an event is caused by the glint signal (e.g., a plurality of events are caused by a series of glint signals). For example, the pixel position where an event is caused by the glint signal may be expressed as, for example, coordinates in an image coordinate system of the event camera, and may also be referred to as a glint image-position.

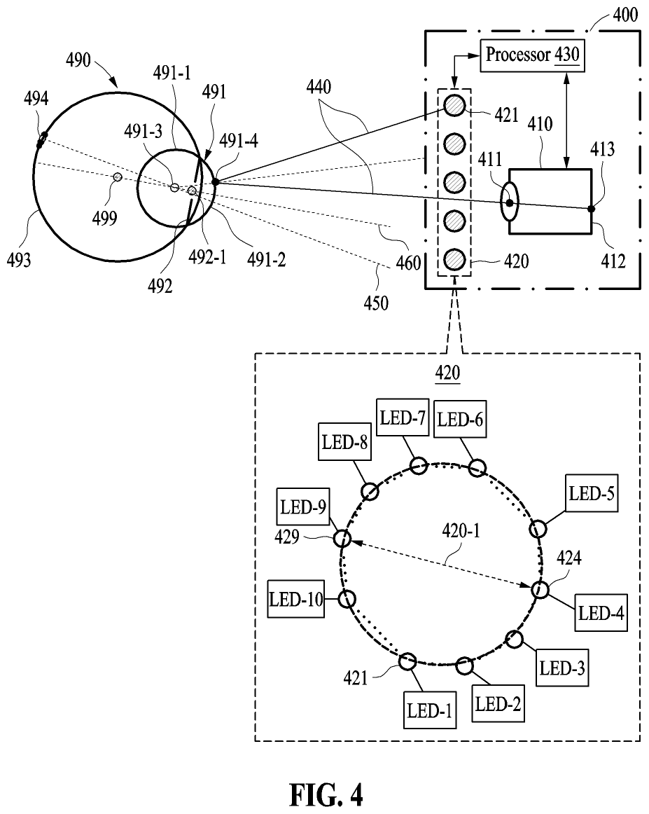

In operation 120, the electronic device may estimate a corneal sphere center position and an eye rotation center position based on the glint information. The corneal sphere center position may be a position corresponding to the center of the corneal sphere. The eye rotation center position may be a position corresponding to the center of eye rotation. The corneal sphere center and the eye rotation center are described below with reference to FIG. 4.

In operation 130, the electronic device may determine three-dimensional (3D) gaze-related information based on the corneal sphere center position and the eye rotation center position. The 3D gaze-related information may be information indicating a gaze direction corresponding to an eye in a 3D space, for example, it may include the angles formed by the gaze direction (e.g., gaze axis) with respect to three spatial axes (e.g., x-axis, y-axis, and z-axis) of the 3D space, but is not limited thereto. That is, the gaze direction may be a ray with its endpoint at the eye (e.g., a coordinate in a 3D space) and a 3D direction from the endpoint. The gaze direction of an eye may also be referred to as an eye visual axis or a 3D gaze.

In a 3D gaze tracking method according to one or more embodiments, a 3D gaze may be determined without pupil information (e.g., without detecting or tracking a pupil). After obtaining the glint information, the electronic device may determine the 3D gaze-related information (3D gaze) without needing to obtain through-hole information again. The electronic device may determine the 3D gaze-related information based on the eye rotation center and the corneal sphere center, rather than estimating the pupil center. Therefore, the electronic device may determine the 3D gaze without additional hardware and software to obtain pupil signals. As described above, the electronic device for performing the 3D gaze tracking method may determine the 3D gaze only (or primarily) using the glint information obtained from the event camera (or, without pupil detection/tracking). Since the computational load for generating event data is much lower than the load needed for pupil detection/tracking, low-power and low-latency performance may be obtained for gaze tracking using event data. For example, an electronic device implemented as an extended/augmented reality device (e.g., a head-mounted display (HMD) device) may have limited speed and power consumption, and yet may determine a 3D gaze more efficiently at a lower cost through gaze tracking using the event data described above.

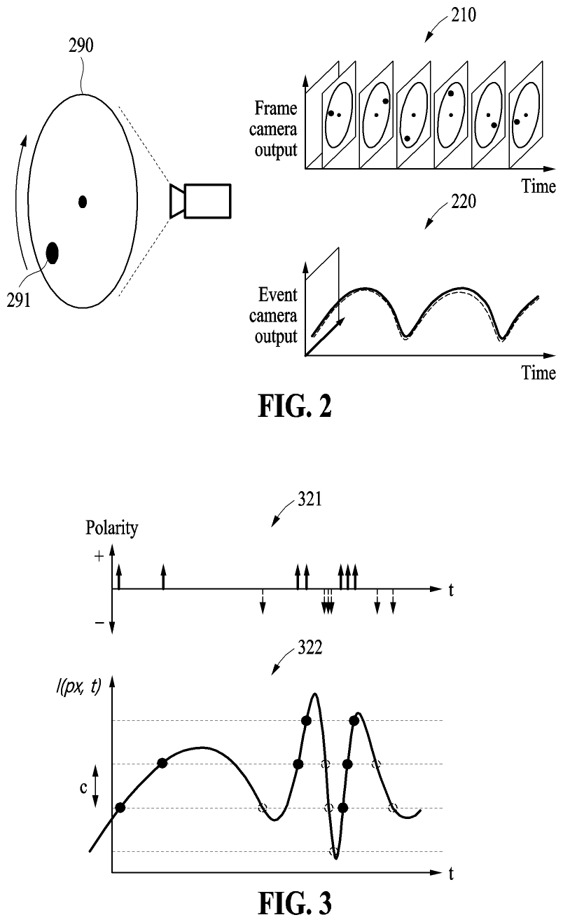

FIGS. 2 and 3 illustrate an example of an operating principle of an event camera, according to one or more embodiments.

The event camera mentioned above may be a vision sensor that, compared to standard frame cameras, only (or specifically) measures changes in the scene and outputs an event stream. In some implementations, the event camera may have multiple sensors, including a standard RGB sensor (and/or an infrared sensor) as well as a sensor configured for glint detection. A standard frame cameras may be a camera that captures image frames and may include, for example, a color camera (e.g., an RGB camera) or a grayscale camera.

FIG. 2 shows an example of capturing the rotation of a circular object 290 with a point 291 thereon. Output data from a standard frame camera may include frame images over time. As shown in the upper timeline of FIG. 2, a standard frame camera may periodically output frame images regardless of whether the circular object 290 rotates (e.g., at a constant rate, regardless of behavior of the circular object 290). As described above, and as shown in the lower timeline of FIG. 2, the output data (e.g., event data) from the event camera may include the position of a pixel where an event (e.g., brightness change) occurs, the time when the event occurs, and the direction (e.g., polarity) of the brightness change, as described above. The event camera may output, according to a position change of the point 291 in response to the rotation of the circular object 290, event information about a pixel corresponding to the position (e.g., the position of the point 291) at which the brightness changes.

A pixel (e.g., sensing element) of the event camera may operate independently and asynchronously from other pixels of the event camera. The event camera may sense the change (e.g., the pixel where an event occurs) at a microsecond resolution (e.g., every microsecond), and output event information when the event is triggered. The event information (an event) may include the position (x, y), polarity s, and timestamp t of the event, and may be expressed in the form of a tuple, for example, with these pieces of information. The timestamp t may be the time point when the event occurs. To summarize, the event camera may report event data including one or more pieces of event information.

As shown in FIG. 2, the time interval (e.g., sampling period) between frame images in output data 210 (e.g., video data) from a standard frame camera may be greater than the sensing interval of an event camera. Event data 220 output from an event camera may include only (or primarily, or without full-frame images) the position, polarity, and timestamp of the event as described above and thus, may be lighter than the output data 210 from the standard frame camera including frame images. Accordingly, the event camera may respond to changes in the scene with a microsecond delay and operate with low power (e.g., 5 mW).

FIG. 3 illustrates an example of an event trigger of an event camera, according to one or more embodiments. Intensity information 322 (e.g., an intensity graph (upper)) and polarity information 321 as a function of time (lower) are shown in FIG. 3. In the intensity information 322, the vertical axis denotes the intensity of a predetermined pixel at a predetermined time point, and the horizontal axis may denote time. The predetermined pixel is representative of any pixels of the event camera. In the polarity information 321, the vertical axis denotes a polarity sign, and the horizontal axis denotes time. For example, the event trigger condition for each pixel of the event camera may be expressed as Equation 1 below.

$$log I ( px , t ) - log I ( px , t - Δ t ) = \pm C \qquad Equation 1$$

In Equation 1 above, I(px, t) denotes the signal intensity of a glint, px denotes a pixel corresponding to the glint, and tdenotes time. Δt denotes a sensing time interval corresponding to the time resolution (e.g., on the order of microsecond(s) of resolution) of the event camera. C denotes a threshold of change. The direction of an arrow in FIG. 3 indicates polarity. Accordingly, the left side of Equation 1 above may denote, for a given/representative sensor pixel, a change between intensities at two adjacent time points. According to Equation 1 above, the change between intensities may be the difference (e.g., absolute difference) between logarithmic values of the intensities. If the change between the intensities at two adjacent time points at a predetermined pixel (e.g., px) satisfies the threshold, an event may be triggered at that pixel.

Therefore, if Equation 1 above is satisfied, an event may be triggered, and the event camera may capture the triggered event and output event information (an event) for the corresponding time point. The event camera may sense a new event when an intensity change from the intensity value of a previous event (e.g., the latest event) satisfies the threshold. Referring to FIG. 3, each time a change log I(px, t)−log I(px, t−Δt) between the intensity I(px, t−Δt) at a first time point and the intensity I(px, t) at a second time point reaches the threshold (e.g., +C or −C), an event may be triggered. The second time point may be the time point when an event is triggered, and the first time point may be the time point when an event is triggered immediately before the second time point. However, examples are not limited thereto, and if the change between intensities (e.g., the absolute value of the change) is greater than or equal to the threshold, an event may be triggered.

As described above, since the event camera generates event data corresponding to an event triggered in response to the trigger condition (e.g., the condition in Equation 1), the event camera may have low sensing latency and low power consumption. The event camera may be used as a gaze tracking sensor in mobile or on-person platforms (e.g., augmented reality/virtual reality (AR/VR) devices), for example.

FIG. 4 illustrates an example of an optical path along which light emitted from a light source reaches an event camera via a glint, according to one or more embodiments.

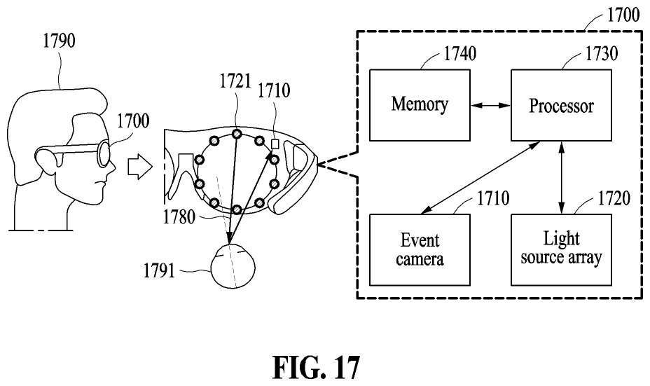

According to an embodiment, an electronic device 400 may include an event camera 410, a light source array 420, and a processor 430. The light source array 420 may include light sources 421, 424, and 429. In FIG. 4, the geometry of the plurality of light sources 421, 424, and 429, the event camera 410, and an eye (eyeball 490, cross-sectional view) is conceptually shown. A cross-sectional view of the eye's cornea 491 is also shown. For reference, as described later, FIG. 17 shows an exemplary positional relationship between the head of a user and the light source array 420 and the event camera 410 of the electronic device 400 when the electronic device 400 is implemented as a head-mounted device.

With the example optical path described below, light emitted from a predetermined light source 421 among the multiple light sources 421, 424, and 429 may be reflected as a glint 491-4 off of the corneal surface 491-2 of the eye. The reflected light may be captured on a capturing plane of the camera. For example, the reflected light may pass through the optic center 411 of the camera and be captured. A glint image point 413 may be captured on an image plane 412 corresponding to the capturing plane. The glint image point 413 may be a point corresponding to a pixel, on the image plane 412, receiving a signal (e.g., a glint signal) corresponding to the glint 491-4.

Referring to FIG. 4, the eye (e.g., the eyeball 490) of the user wearing the electronic device 400 (e.g., the head-mounted device) is shown in simplified form as having a cornea 491, an iris 492, a retina 493, and a fovea 494 (e.g., fovea centralis).

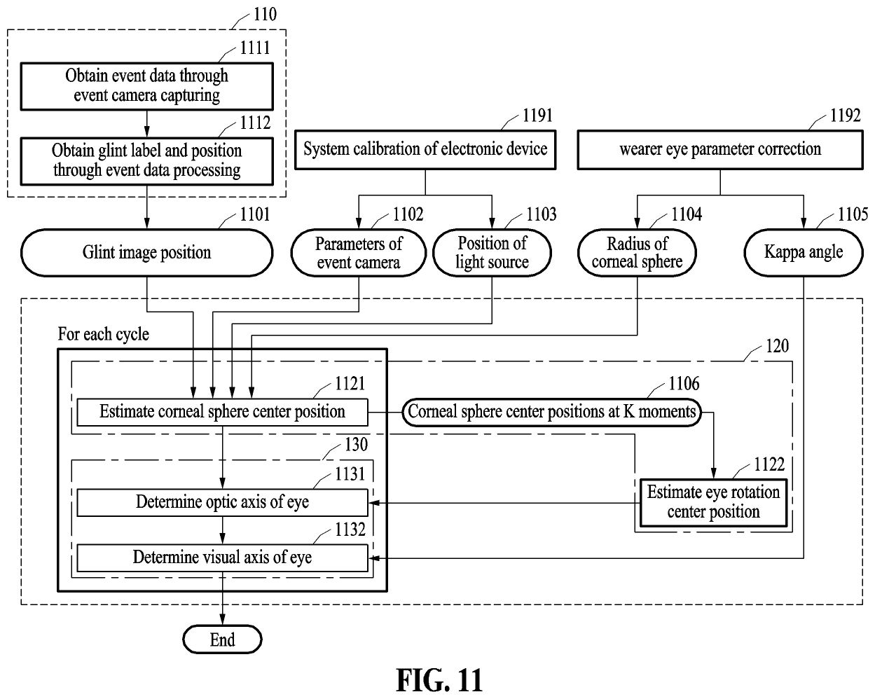

A corneal sphere 491-1 may be a modeled sphere corresponding to the cornea 491, for example, it may be a modeled sphere corresponding to the cornea surface 491-2. The corneal surface 491-2 may be a curved surface, and the corneal sphere 491-1 may be a sphere modeled and/or approximated based on the corneal surface 491-2. The radius of the corneal sphere 491-1 may be predetermined and, for example, may be the average radius of the general population. However, examples are not limited thereto, and a radius corrected according to the eyeball 490 (or the eye) of the wearer may be used in the example of FIG. 11 below. A corneal sphere center 491-3 may be positioned at the center indicated by the corneal curvature (e.g., the center of the corneal sphere 491-1) and on the eye's visual axis 450 (e.g., visual axis). The eye visual axis 450 may also be referred to as a visual line or line of sight. The visual axis 450 may be an axis passing through the corneal sphere center 491-3 from the fovea 494. The optic axis 460 of the eye may pass through an eye rotation center 499, the corneal sphere center 491-3, and a pupil center 492-1. The corneal sphere center 491-3, as described below, may be determined through a numerical search algorithm based on the geometric constraints of rays 440 (e.g., rays incident on the eye and rays reflected from the eye) and the corneal sphere radius.

Since the cornea 491 (or the corneal sphere 491-1) is a fixed part of the rotating eye, the cornea 491 may rotate about the eye rotation center 499.

According to one or more embodiments, the event camera 410 may capture a glint signal of light emitted from a light source and reflected from the corneal sphere surface (e.g., the corneal surface 491-2). The event camera 410 may enable determining a 3D gaze of the eye using glint information obtained by capturing the glint signal, for example, by the processor 430. The 3D gaze may be the eye visual axis 450 in FIG. 4.

The light sources 421, 424, and 429 may be arranged on a same plane, and the plane on which the sources 421, 424, and 429 are positioned may intersect (e.g., be orthogonal to) the optical axis of the camera (e.g., the event camera 410). When viewed in a direction perpendicular to the plane on which the light sources 421, 424, and 429 are arranged, for example, the 421, 424, and 429 of the light source array may be arranged in a circle on a predetermined plane. Of the light sources 421, 424, and 429, light sources 424 and 429 (e.g., two light sources) corresponding to predefined light source codes (e.g., key codes) of a light source code set may be spaced apart from each other by the diameter 420-1 of the circle described above. A code is a bit sequence. However, the above arrangement of the light sources 421, 424, and 429 is merely an example and may vary depending on the design.

According to an embodiment, the processor 430 of the electronic device 400 may obtain glint information by processing event data generated through sensing by an event sensor. For example, the electronic device 400 may obtain the event data in response to capturing the glint signal in operation 110 described above with reference to FIG. 1. The event data may include event information corresponding to multiple events. The electronic device 400 may determine the glint information from event information generated in response to the reflection of light emitted from a light source, among pieces of event information. The glint information may include a glint image position. The glint image position may be the position of the glint 491-4 corresponding to the light source 421 in an image coordinate system of the event camera.

According to an embodiment, the electronic device 400 may determine the glint information by analyzing a brightness change sequence of the event data. The brightness change sequence may, by way of example, represent sequential brightness changes within a given time interval. The given time interval may be, for example, a time interval corresponding to n operation cycles corresponding to n bits, where n may be an integer greater than or equal to “1”. As described below, since the electronic device 400 operates each light source to blink/pulse according with its own unique respective code (e.g., light source code), brightness change events (e.g., a brightness change sequence) sensed by the event sensor may correspond to a bit sequence of the code (that is, brightness changes may be tied to specific light sources by their bit sequences/pulse pattern). In addition, since a unique code is mapped to each light source as described below, the electronic device 400 may identify a light source corresponding to the sensed brightness change sequence among the light sources 421, 424, and 429 based on the analysis of the brightness change of the event data. Accordingly, the electronic device 400 may distinguish and independently determine glint information by two or more light sources among the plurality of light sources 421, 424, and 429.

For example, labels of the respective different light sources 421, 424, and 429 may be coded using respective multi-bit binary codes. Each label may be an identifier indicating a corresponding light source. The multi-bit binary codes may also be referred to as binary codes, or light source codes. The label of each light source may be mapped to a unique light source code. Table 1 and Table 2 below show examples of mapping between labels of light sources and light source codes.

The electronic device 400 may operate each of the light sources 421, 424, and 429 according to a corresponding light source code (e.g., bit sequence). Each of the light sources 421, 424, and 429 may operate according to a corresponding unique light source code of the light source code set. Each light source may perform a series of light emissions corresponding to its light source code. For example, one operation cycle may correspond to one bit value of the light source code. When the bit value of a bit position in a bit sequence of a light source code is “0”, the electronic device 400 may turn on the light source only during a first partial interval in the operation cycle for the bit position (e.g., an interval corresponding to ⅓ of the operation cycle) and turn off the light source during the other second interval (e.g., an interval corresponding to the remaining ⅔ of the operation cycle). The first partial interval may be an interval preceding the second partial interval. When the bit value of the predetermined bit position in the bit sequence is “1”, the electronic device 400 may turn on the light source only during a partial interval in the operation cycle for the bit position (e.g., an interval corresponding to ⅔ of the operation cycle) and turn off the light source during the other interval (e.g., an interval corresponding to the remaining ⅓ of the operation cycle). A 4-bit light source code may be expressed by operating a light source for four operation cycles and turning the light source on and off for the intervals corresponding to the vit values of the 4-bit light source code.

The electronic device 400 may identify a bit sequence matching a sensed brightness change sequence of the event data, thereby determining the label of the light source 421 causing the brightness change sequence at the glint 491-4. The electronic device 400 may obtain the glint image position of the glint 491-4 corresponding to the light source 421 with the identified label (here, glint 491-4 is representative of any other glint). In other words, by decoding the pattern of light from a glint during the intervals of an operation cycle, the electronic device 400 may obtain the bit pattern of the light source corresponding to the glint, and may obtain, from a table, the identity of the light source causing the glint.

For reference, if synchronization between the camera and the light source is inaccurate or unavailable, it may be difficult to accurately identify the start bit of the light source's bit sequence using only the operation timing of the light source and the sensing timing of the camera. A start bit may indicate a first bit value (e.g., the most significant bit (MSB)) in a bit sequence mapped to a predetermined light source. For example, if the bit sequence is “0001”, the start bit may be “0” of the MSB. A light source may periodically emit light according to its bit sequence, and the camera may first capture a light emission sequence corresponding to the last two bits “01” of “0001” and then capture a light emission sequence corresponding to the first two bits “00” later, for the glint 491-4. In this case, the identified bit sequence may be “0100”. Therefore, from the perspective of the event camera, there may be ambiguity in that it is difficult to identify “0001” and “0100”.

The electronic device 400 may provide, to a light source, a light source code determined by anti-ambiguity coding. The ambiguity in determining the start bit of a bit sequence may be reduced by anti-ambiguity coding. Therefore, even if the electronic device 400 fails to identify the start bit from the brightness change sequence of the event data, the electronic device 400 may more accurately determine the label of the light source 421 based on the results of identifying the remaining bit values from the brightness change sequence.

According to an embodiment, a unique light source code determined based on the anti-ambiguity coding method may be mapped to each of the plurality of light sources 421, 424, and 429 (e.g., ten light sources). A set of light source codes mapped to the respective light sources 421, 424, and 429 may be referred to as a light source code set. Herein, a light source may be, for example, a light-emitting diode (LED) lighting, but is not limited thereto. For example, to code the ten light sources 421, 424, and 429, a 4-bit binary number may be required. A total of sixteen different codes may be generated from the 4-bit binary number. Ten of the sixteen different codes may be selected as the codes (e.g., light source codes) for the ten light sources 421, 424, and 429. In Table 1 below, ten codes (e.g., a light source code set) selected as an example are described.

TABLE 1

| Label | Code | Code ambiguity | Start bit ambiguity |
|---|---|---|---|
| LED-1 | 0 0 0 0 | Unambiguous | Ambiguous |
| Not used | 0 0 0 1 | Ambiguous | Unambiguous |
| Not used | 0 0 1 0 | Ambiguous | Unambiguous |
| Not used | 0 1 0 0 | Ambiguous | Unambiguous |
| LED-2 | 1 0 0 0 | Unambiguous | Unambiguous |
| LED-3 | 1 1 1 1 | Unambiguous | Ambiguous |
| LED-4 | 0 0 1 1 | Ambiguous | Unambiguous |
| LED-5 | 1 0 0 1 | Ambiguous | Unambiguous |
| LED-6 | 1 1 0 0 | Ambiguous | Unambiguous |
| LED-7 | 0 1 1 0 | Ambiguous | Unambiguous |
| LED-8 | 0 1 0 1 | Ambiguous | Ambiguous |
| LED-9 | 1 0 1 0 | Ambiguous | Ambiguous |
| LED-10 | 0 1 1 1 | Unambiguous | Unambiguous |
| Not used | 1 0 1 1 | Ambiguous | Unambiguous |
| Not used | 1 1 0 1 | Ambiguous | Unambiguous |
| Not used | 1 1 1 0 | Ambiguous | Unambiguous |

The codes marked as “Unambiguous” for the code ambiguity in Table 1 may indicate that it is possible to continuously recognize (differentiate) the labels of the codes (e.g., the labels of the light sources corresponding to the codes or the labels of the glint 491-4 corresponding to the codes) even when the start bits are unknown.

For example, even when the start bit is unknown, if there are four consecutive bits including three “0”s and one “1” (e.g., in any order) at the glint 491-4, the consecutive bits may come from the codes “0001”, “0010”, “0100”, and “1000”. Here, when the codes “0001”, “0010”, and “0100” are excluded from mapping for the light sources, “1000” may be the only code having three “0”s and one “1” in the light source code set. Therefore, for example, if the codes “0001”, “0010”, and “0100” are not used, the electronic device 400 may determine the four consecutive bits including three “0”s and one “1” at the glint 491-4 to be a bit sequence of “1000” even when the start bit is unknown. The electronic device 400 may determine “1000” even if bit the values of “1000” are detected at a random time. Therefore, in the exemplary light source code set described above, “1000” is a code without ambiguity. In other words, if the codes “0001”, “0010”, and “0100” are not used, the code “1000” may be easily recognized. The electronic device 400 may determine the label of a light source corresponding to an unambiguous code without confusion with the other codes. Accordingly, the electronic device 400 may accurately determine the label of the glint 491-4 in the event data by identifying the code without ambiguity and without requiring synchronization between the light sources and the event camera.

A code marked with “Unambiguous” for the start bit ambiguity may be a code, the start bit of which is deterministically recognizable when the label of the code is known. For example, the electronic device 400 may recognize the start bit by detecting the occurrence of a bit value of “1” of the first position (e.g., the MSB) for “1000”. This is because “1000” has one “1”. When a bit value of “1” is identified from the event information occurring at the glint 491-4 corresponding to a light source operating with the bit sequence of “1000”, the bit value of “1” may be the bit value corresponding to the start bit.

A code without code ambiguity and without start bit ambiguity may be referred to as an “unambiguous code”. An “unambiguous code” may be predefined, and may also be referred to as a “predefined light source code”. A predefined light source code may be a bit sequence that can be uniquely determined without ambiguity, compared to other bit sequences in a light source code set satisfying a predetermined condition. For example, the predetermined condition may be a condition without code ambiguity and start bit ambiguity mentioned in the example in Table 1. For example, the light source codes of the light source code set corresponding to Table 1 may be respectively mapped to the light sources 421, 424, and 429. The electronic device 400 may control a predetermined light source using a bit sequence mapped to the light source. In the code described in Table 1 above, a bit value of “1” may indicate a state in which a light source is turned on, and a bit value of “0” may indicate a state in which a light source is turned off. According to the rules described above, the two codes “1000” and “0111” of the light source codes in Table 1 have no code ambiguity or start bit ambiguity and thus, may have excellent performance in simultaneously identifying their labels and start bits.

As previously described, the electronic device 400 may capture a glint signal of light emitted from a light source and reflected from the corneal sphere surface using the event camera. The electronic device 400 may obtain glint information by processing event data obtained based on the glint signal. For example, the electronic device 400 may obtain a bit sequence for the glint 491-4 based on frequency filtering on the event data. The obtained bit sequence may include bit values by which the light source was driven. As described above, the electronic device 400 may turn on the light source when the bit value is “1” and turn off the light source when the bit value is “0”. The electronic device 400 may determine a predefined light source code among the light source codes in the light source code set. The predefined light source code is a code that can be uniquely identified in a light source code set satisfying a predetermined condition (e.g., no-ambiguity condition), and may also be referred to as a “key code”, whose function is described next.

The electronic device 400 may operate/drive the light sources 421, 424, and 429 according to the light source code set described above, and may obtain event data for glints corresponding to the respective light sources 421, 424, and 429. The electronic device 400 may identify a light source code (that matches the binary code) according to the brightness change sequence obtained by analyzing the event data. For example, the electronic device 400 may detect, using the event camera, brightness change sequences at glints respectively corresponding to the light sources 421, 424, and 429 at respective positions (e.g., pixel positions). Each of the brightness change sequences may correspond to a respective binary code; a set of binary codes corresponding to the brightness change sequences may also be referred to as a binary code sequence. The electronic device 400 may determine, from among the binary codes identified from the brightness change sequences, a binary code that matches the key code. The electronic device 400 may identify the label of the light source mapped to the key code, for the glint 491-4 at which the binary code matching the key code appears. In response to identifying the binary code matching the key code (among the binary codes obtained through analysis of the event data), the electronic device 400 may determine a timestamp corresponding to the start bit of the bit sequence whose binary code matched the key code. Since the electronic device 400 controls the light sources 421, 424, and 429 at the same timing using the light source code set, the timestamp corresponding to the start bit of the matched binary code may be the same as or similar to the timestamps corresponding to the start bits of the remaining binary codes. The electronic device 400 may determine a glint label of another glint based on the timestamp and a predefined code rule of the light source. The electronic device 400 may obtain glint image positions of glints −4 corresponding to the determined glint labels as glint information. To summarize, by identifying light (e.g., a glint) of a light source emitting the key code, a start bit time of that light source may be used to determine the start bits of the other light sources (the key binary code start bit will coincide with the start bits of the other binary codes), and thus associations of glints with light sources may be determined.

The electronic device 400 may identify binary codes (e.g., a binary code sequence including multiple binary codes) respectively corresponding to glints from the result of analyzing the event data. The electronic device 400 may determine the binary code matching the key code from the binary code sequence. For example, if the light source code set is designed as shown in Table 1, the electronic device 400 may obtain the binary code sequence and then determine the key code (e.g., the code “1000” or “0111”). The electronic device 400 may determine the start bit of the bit sequence of the binary code detected for the glint 491-4 using a light source code of one of the key codes. The electronic device 400 may determine the key code (e.g., “1000” or “0111”) that matches the binary code detected for the predetermined glint 491-4. The electronic device 400 may determine a bit corresponding to the start bit of the key code among the bits of the detected binary code to be the start bit of the detected binary code. The electronic device 400 may use a timestamp of the start bit of the detected binary code as a timestamp for the start bit of another binary code. Accordingly, the timestamp corresponding to the start bit of the binary code determined based on the start bit of the key code may be used as a start timestamp of the other detected binary codes (e.g., the binary code sequence). The electronic device 400 may determine the labels of the light sources 421, 424, and 429 corresponding to the binary codes, based on the start timestamp of the binary code sequence.

For example, the electronic device 400 may determine start bits of ambiguous binary codes (e.g., binary codes other than the key code of the light source code set) based on the timestamp of the start bit according to an unambiguous code (e.g., the key code) and code rules of the light sources (e.g., the light source code set). The electronic device 400 may determine light source codes matching the binary codes (e.g., the key code and the ambiguous binary codes) based on the determined start bits. The electronic device 400 may search for a light source code matching a binary code and thus determine the label of the light source from the light source code set (e.g., the table according to Table 1).

One light source may correspond to one glint (e.g., light source 421 may correspond to glint 491-4), and the label of the light source may be the label of the glint. After determining the labels of the respective concurrent glints, the electronic device 400 may obtain the glint image positions of the respective labeled glints 4 as glint information. For example, as shown in FIG. 4, the electronic device 400 may determine, for a glint corresponding to a glint label, the position of the thus-labeled glint (e.g., the glint image position) on the image plane 412 based on the glint and the camera optic center. In other words, the image positions of glints from specific light sources may be identified.

As described above, the key code may be used to identify the start bit of a bit sequence. Some flickering may be lost in a corneal area when an eye is looking to the side, and the glint 491-4 from the light source corresponding to the key code may be disposed to be visible to the event camera. For example, to prevent flickering of at least one of the light sources 424 and 429 corresponding to the key codes, the distance between the light sources 424 and 429 corresponding to the key codes may be predetermined. In a light source array of light sources, two or more light sources respectively corresponding to key codes of the light source code set may be spaced apart by the predetermined distance. For example, if all light sources are arranged in a single circle, the light sources 424 and 429 corresponding to the key codes may be spaced apart from each other by one diameter 420-1 in the circle.

For example, in the code design of Table 1, both “1000” and “0111” may be key codes. Referring to FIG. 4, all light sources 421, 424, and 429 may be arranged in a single circle. For reference, for ease of description, an example in which all light sources 421, 424, and 429 are spaced apart at equal intervals along the circumference of the circle is shown, but examples are not limited thereto. The label of the first light source 421 may be LED-1, the label of the fourth light source 424 may be LED-4, and the label of the ninth light source 429 may be LED-9. The other light sources may be similarly labeled. Key codes may be mapped to some of the light sources 421, 424, and 429. For example, the key code “1000” may be mapped to the fourth light source 424, and the key code “0111” may be mapped to the ninth light source. The light sources to which the key codes are mapped may be arranged to be spaced apart by a predetermined distance (e.g., maximally distant). The fourth light source 424 and the ninth light source 429 may be spaced apart by the predetermined diameter 420-1.

In the manner described above, the ambiguity in determining the start bit of the bit sequence may be reduced, and the accuracy of the obtained glint information may be improved.

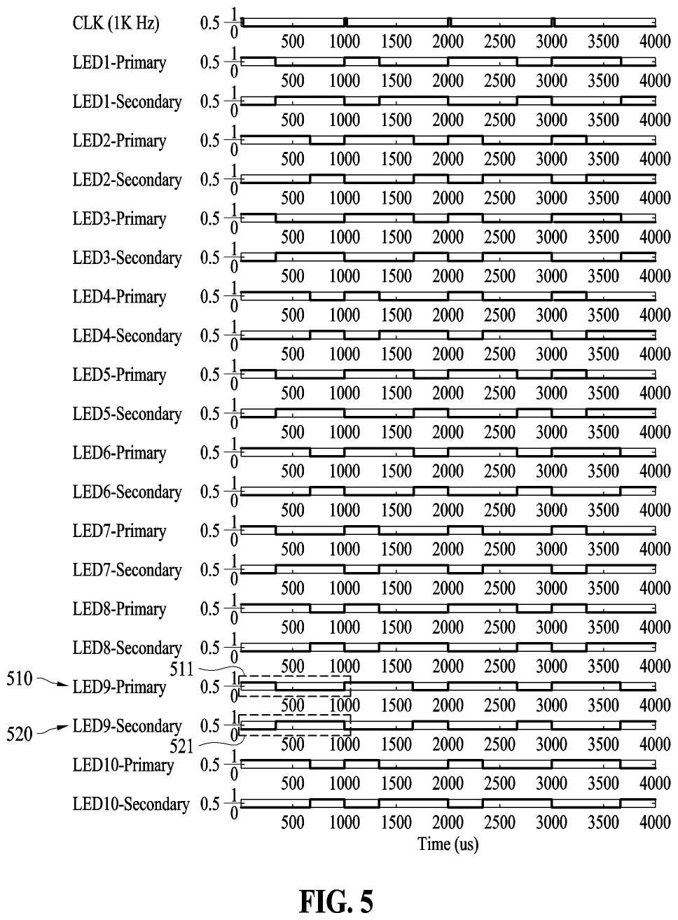

FIG. 5 illustrates an example of a timing diagram of signals to control/drive light-emitting diode (LED) light sources using an improved coding scheme, according to one or more embodiments.

In a light source code set according to an embodiment, a key bit of a light source corresponding to a key code and a key bit of a code of another light source adjacent to the light source may be configured to be different. For example, in a light source array of light sources, a key bit of a light source corresponding to a key code (in a light source code set) and a key bit of a light source adjacent to the light source may be different. A key bit may be a predefined code bit in a light source code, and may indicate the bit value of a predetermined bit position in a bit sequence corresponding to the light source code. The key bit may be, for example, a start bit (e.g., an MSB). Based on the light source corresponding to the key code, different key bits may be mapped to light sources adjacent to each other (e.g., LED lights adjacent to each other). For example, the predetermined bit position may be the MSB, and the key bit (e.g., the predefined code bit) may be the start bit, which is the first bit of the code. Therefore, since it is easy to identify the start bit, errors in the process of identifying the start bit may be reduced.

For example, referring to FIG. 5, LED-9 may be a label indicating a light source corresponding to a key bit. Referring to the arrangement of the light sources shown in FIG. 4, LED-9-Primary may indicate the light source LED-9, and LED-9-Secondary may indicate the light sources LED-8 and LED-10 adjacent to the light source LED-9. Referring to a timing diagram 510 of a light source code provided to the light source LED-9, the light source LED-9 may be turned on only in a ⅓ interval of an operation cycle 511 corresponding to a first bit. Accordingly, the first bit may be “0” in the timing diagram 510 of the light source LED-9. Referring to a timing diagram 520 of a light source code provided to the adjacent light source LED-8 or LED-10, the light sources may be turned on in a ⅔ interval of an operation cycle 521 corresponding to a first bit. Therefore, the first bit of the adjacent light source may be “1”. Based on the above considerations, the coding method shown in Table 1 may be further improved to a coding method shown in Table 2.

TABLE 2

| Label | Code | Code ambiguity | Start bit ambiguity |
|---|---|---|---|
| Not used | 0 0 0 1 | Ambiguous | Unambiguous |
| Not used | 0 0 1 0 | Ambiguous | Unambiguous |
| Not used | 0 1 0 0 | Ambiguous | Unambiguous |
| LED-1 | 0 0 1 1 | Ambiguous | Unambiguous |
| LED-2 | 1 1 0 0 | Ambiguous | Unambiguous |
| LED-3 | 0 1 0 1 | Ambiguous | Ambiguous |
| LED-4 | 1 0 0 0 | Ambiguous | Unambiguous |
| LED-5 | 0 1 1 0 | Ambiguous | Unambiguous |
| LED-6 | 1 1 1 1 | Unambiguous | Ambiguous |
| LED-7 | 0 0 0 0 | Unambiguous | Ambiguous |
| LED-8 | 1 0 1 0 | Ambiguous | Ambiguous |
| LED-9 | 0 1 1 1 | Unambiguous | Unambiguous |
| LED-10 | 1 0 0 1 | Ambiguous | Unambiguous |
| Not used | 1 0 1 1 | Ambiguous | Unambiguous |
| Not used | 1 1 0 1 | Ambiguous | Unambiguous |
| Not used | 1 1 1 0 | Ambiguous | Unambiguous |

The electronic device may control the light sources using the light source codes (e.g., the light source code set) designed as shown in Table 2 above. As described above, in a light source code, the value of “1” may indicate a state in which a light source is turned on, and the value of “O” may indicate a state in which a light source is turned off.

In the example of FIG. 5, the light source array may include each light source LED-Primary and a light source LED-Secondary adjacent to the light source. The light source LED-Primary and the light source LED-Secondary may be in inverse states (e.g., the turned-on state or the turned-off state) in each operation cycle. When the light source LED-Primary is turned on, the light source LED-Secondary is turned off. When the light source LED-Secondary is turned off, the light source LED-Primary is turned on. In FIG. 5, the turned-on state is shown as a high level (e.g., a logic level corresponding to the bit value of “1”), and the turned-off state is shown as a low level (e.g., a logic level corresponding to the bit value of “0”).

Table 2 shows the codes of the light sources LED-Primary. Referring to the timing diagram for the light source LED-1 Primary of FIG. 5, the electronic device may recognize, for example, that the light source is turned on for the first ⅓ time and turned off for the last ⅔ time in first and second clock cycles among four clock cycles (CLK). A clock cycle may be an operation cycle. The electronic device may recognize that the light source is turned on for the first ⅔ time and turned off for the last ⅓ time in third and fourth clock cycles. The electronic device may determine a binary code “0011” from a brightness change sequence at a glint caused by turning on and off the light source. Referring to Table 2, the electronic device may identify the label of a light source as being LED-1 for the binary code “0011”. The electronic device may determine the label of the glint corresponding to that light source to be “1” (for LED-1).

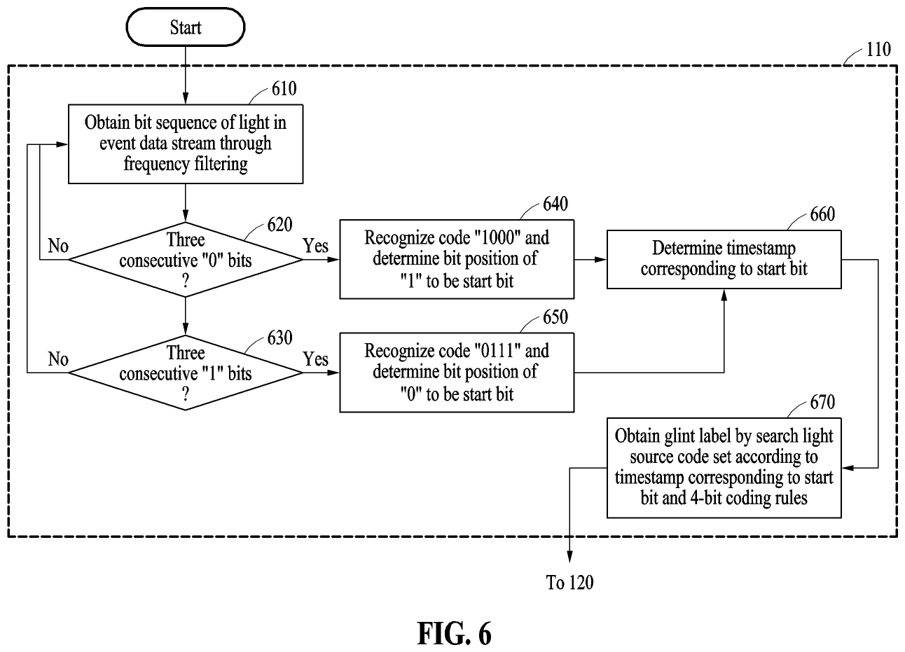

FIG. 6 illustrates an example of obtaining, by an electronic device, a glint label based on a light source code set, according to one or more embodiments.

When operating light sources with the light source code set according to the coding method of Table 2, the electronic device according to one or more embodiments may obtain glint labels using the method shown in FIG. 6. Examples of detailed operations of operation 110 are described below.

In operation 610, the electronic device may obtain a bit sequence of a glint from an event data stream through frequency filtering. An event stream may be event data and include a series of pieces of event information (i.e., events). The bit sequence of the glint may also be referred to as a “01 state sequence”.

In operation 620, the electronic device may recognize whether there are three consecutive “0” bits in the bit sequence. In operation 630, the electronic device may recognize whether there are three consecutive “1” bits in the bit sequence. In the case of either operation 620 or 630 not finding three consecutive “1” or “0” bits, operation 610 may be repeated to obtain another bit sequence (that is, a group of concurrently captured bit sequences may be tested to find the one that has the sought bit pattern for identifying a start bit).

In operation 640, the electronic device may recognize a code “1000” if there are three consecutive “0” bits, and determine the start bit of the bit sequence to be the bit position where “1” is positioned.

In operation 650, the electronic device may recognize a code “0111” if there are three consecutive “1” bits, and determine the start bit of the bit sequence to be the bit position where “O” is positioned.

In operation 660, the electronic device may determine a timestamp corresponding to the start bit.

In operation 670, the electronic device may obtain the label of the glint by searching the light source code set (e.g., the table according to Table 2) according to the timestamp corresponding to the start bit and the 4-bit coding rules. In addition, the timestamp may be applied to other bit sequences in the event data stream to determine their start bits and thus allow the labels of the other bit sequences to be determined according to Table 2, for example.

In operations 610 to 670 described above, an example of obtaining the glint label for a moment has been described. The electronic device may obtain, for a glint at each moment, a glint image position along with a light source label as glint information. A glint image position corresponding to a predetermined light source may indicate the position of a glint of a corresponding light source in an image coordinate system of an event camera. The position of the glint corresponding to the light source in the image coordinate system may be the position of the glint on the image plane shown in FIG. 4, and may be, for example, the position of the glint projected through the optic center of the camera on the image plane.

Herein, a “moment” may be a real-time moment or a non-real-time moment. In addition, a moment may be a periodic moment or a non-periodic moment. For example, in periodic moments, the time interval between moments may be predetermined. In non-periodic moments, the length of time between moments may not be fixed. However, the moment is not limited thereto. For example, the moment may be set according to an application scenario of the 3D gaze tracking method according to an embodiment. For example, the moment may be set in real time or in non-real time, and periodically or a-periodically. The moment may also be referred to as the time point. For example, it may be set to obtain glint information every 10 seconds, but examples are not limited thereto.

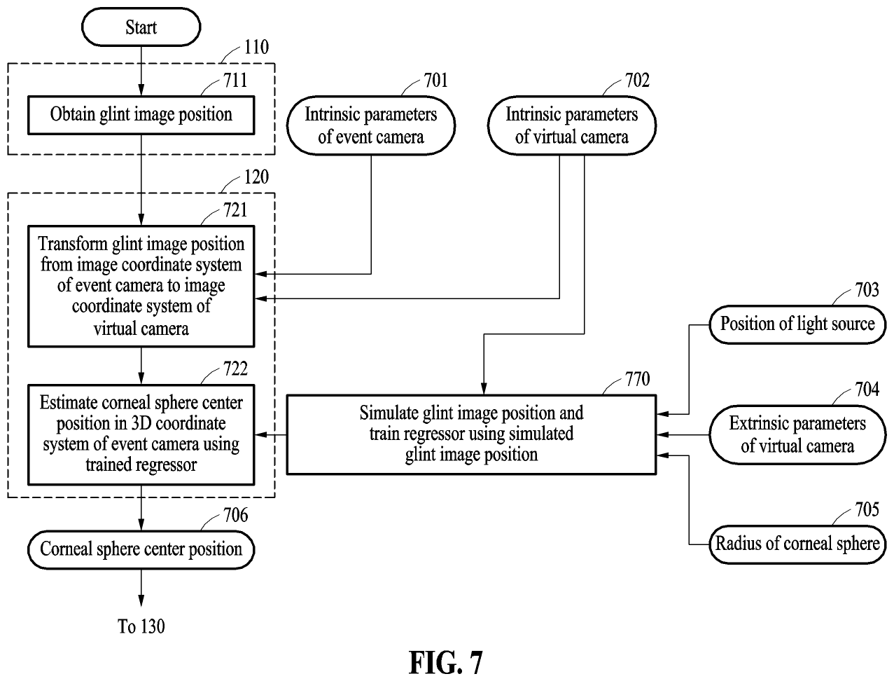

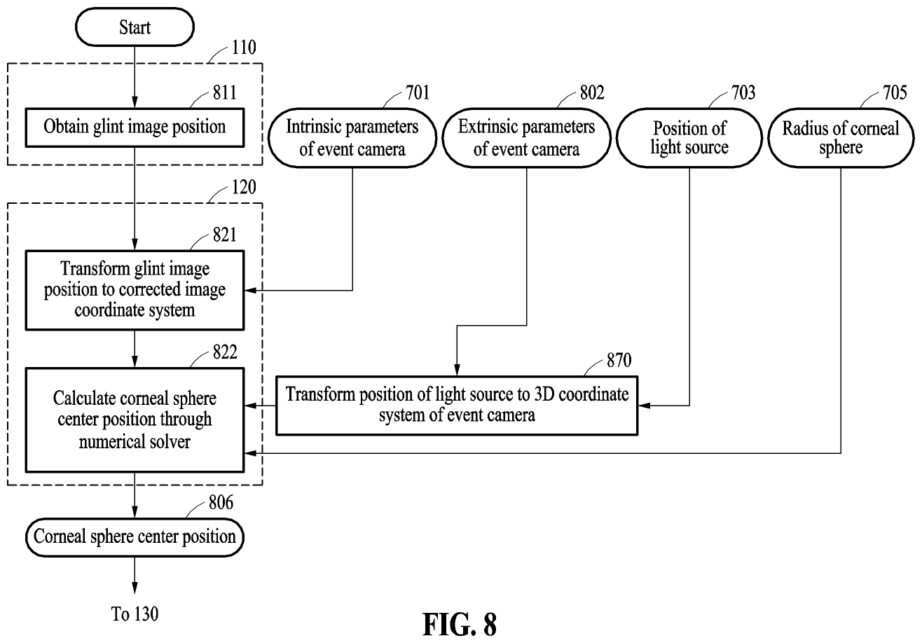

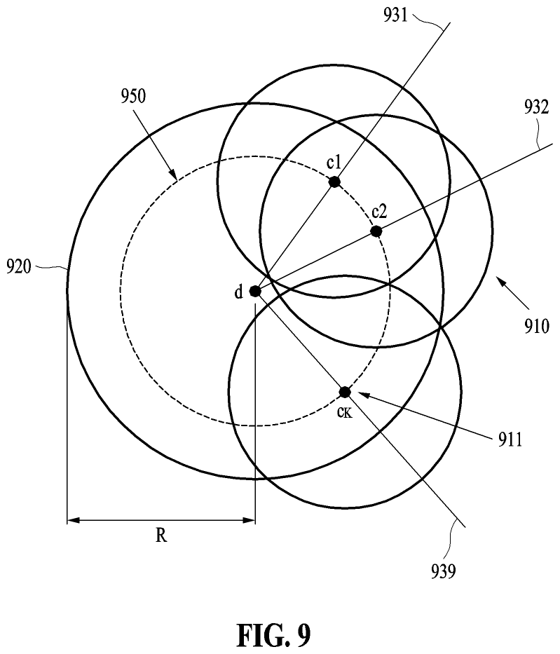

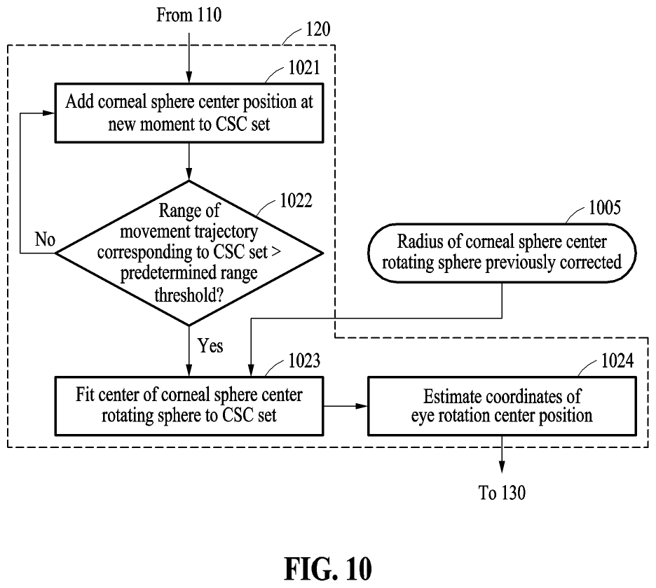

Referring back to FIG. 1, the electronic device may estimate the corneal sphere center position and the eye rotation center position, in operation 120, using the glint information (e.g., the glint label and the glint image position) obtained in operations 610 to 670 described for each moment. According to an embodiment, the electronic device may estimate the corneal sphere center position at each moment based on glint information at the moment. The electronic device may estimate the eye rotation center position based on the distance between a reference eye rotation center and the corneal sphere center and estimated corneal sphere center positions at a plurality of moments. The reference eye rotation center may be determined before a moment of estimating a new eye rotation center position. The estimation of the corneal sphere center position is described below with reference to FIGS. 7 and 8, and the estimation of the eye rotation center position is described below with reference to FIGS. 9 and 10.

FIGS. 7 and 8 illustrate examples of estimating a corneal sphere center position, according to one or more embodiments.

According to an embodiment, an electronic device may estimate a corneal sphere center position 706 or 806 at each moment based on glint information at the moment. In the example of FIG. 7, the electronic device may estimate the corneal sphere center position 706 or 806 at each moment using a regressor, based on a glint image position at the moment. In the example of FIG. 8, the electronic device may estimate the corneal sphere center position 706 or 806 at each moment through a numerical solver, based on a glint image position at the moment, parameters of an event camera, the position of a light source, and the corneal sphere radius. In addition to the examples of FIGS. 7 and 8, various methods may be used to estimate the corneal sphere center position 706 or 806.

According to the example of FIG. 7, the electronic device may estimate the corneal sphere center position 706 at each moment using the regressor based on the glint image position at the moment.

The regressor may also be referred to as a regression model. For example, the regressor may be a linear regressor, a polynomial-based regressor, a machine learning-based regression model, or a neural network-based regressor (e.g., a multi-layer perceptron (MLP)). However, the model for estimating the corneal sphere center position 706 is not limited to the regressor. For example, the machine learning-based regression model may be designed to output the corneal sphere center position 706 from a glint image position at a predetermined moment.

The regressor according to an embodiment may be trained based on a simulated glint image position. The simulated glint image position may be simulated based on a position of light source 703, parameters of a virtual camera corresponding to the event camera (e.g., intrinsic parameters 702 and extrinsic parameters 704 of the virtual camera), and a radius of corneal sphere 705. The intrinsic parameters of the camera (e.g., the event camera or the virtual camera) may be parameters related to the characteristics of the camera itself and may include, for example, the focal length, principal point, and pixel size of the camera. The intrinsic parameters 702 of the virtual camera may include, for example, the focal length, principal point, and pixel size of the virtual camera. The extrinsic parameters of the camera (e.g., the event camera or the virtual camera) may be parameters indicating the position and pose (e.g., rotation direction) of the camera based on the world coordinate system, and may indicate the transformation relationship between coordinate systems (e.g., the camera coordinate system and the world coordinate system). The extrinsic parameters of either camera may include rotation components and translation components between the two coordinate systems. By way of example, the extrinsic parameters 704 of the virtual camera may be parameters indicating the transformation relationship between the world coordinate system and the camera coordinate system of the virtual camera, but examples are not limited thereto.

For example, in operation 770, the electronic device may simulate the glint image position and train the regressor using the simulated the glint image position. The electronic device may obtain the glint image position by performing the simulation based on the position of light source 703, the parameters 702 and 704 of the virtual camera corresponding to (representing) the event camera, and the radius of corneal sphere 705. The electronic device may train the regressor using the simulated glint image position. As described above, the trained regressor may be designed and trained to estimate the corneal sphere center position 706 in a 3D coordinate system of the virtual camera based on the simulated glint image position.

As described above, in operation 120, the electronic device may estimate the corneal sphere center position 706 at each moment using the pre-trained regressor based on the glint image position obtained for the moment.

In operation 711, the electronic device may obtain the glint image position at each moment. Glint image positions (Gix, Giy) may be obtained for the respective N glints. i denotes any of the “1” to “N” glint labels, and since a glint corresponds to a light source, a glint label may be understood as a light source label. Gix is the x-coordinate according to the image coordinate system of an i-th glint, and Giy is the y-coordinate according to the image coordinate system of the i-th glint.

In operation 721, the electronic device may transform the glint image position from the image coordinate system of the event camera to the image coordinate system of the virtual camera. As described above, since the regressor is trained based on the image coordinate system of the virtual camera, the glint image position may be transformed to the image coordinate system of the virtual camera to use the trained regressor. The electronic device may transform the glint image position at each moment from the image coordinate system of the event camera to the image coordinate system of the virtual camera based on the intrinsic parameters 701 among the parameters of the event camera. The intrinsic parameters 701 of the event camera may include the focal length, principal point, and pixel size of the event camera.

For example, the electronic device may transform the glint image position from the image coordinate system of the event camera to the image coordinate system of the virtual camera using Equation 2 below.

$$a * [ {Gix}^{′} , {Giy}^{′} , 1 ] = K\_vir * inv ( K\_cam ) * [ Gix , Giy , 1 ] , \qquad Equation 2$$

In Equation 2 above, “a” denotes a scaling factor used to ensure that the last term of a homogeneous coordinate vector [Gix′, Giy′, 1] is “1”, K_cam denotes the intrinsic parameters 701 of the event camera, K_vir denotes the intrinsic parameters 702 of the virtual camera, [Gix, Giy] denotes the coordinate values indicating the glint image position in the image coordinate system of the event camera, and [Gix′, Giy′] denotes the coordinate values indicating the glint image position in the image coordinate system of the virtual camera. A virtual-physical domain difference caused by a lens actually used in the event camera may be eliminated through the transformation according to Equation 2 described above.

In operation 722, the electronic device may estimate the corneal sphere center position in the 3D coordinate system of the event camera using the trained regressor. For example, the electronic device may estimate, from the glint image position at a predetermined moment, the corneal sphere center position at the moment in the 3D coordinate system of the virtual camera (e.g., the camera coordinate system of the virtual camera) through the regressor. As described above, the glint image position provided to the regressor may have coordinate values according to the image coordinate system of the virtual camera.

The electronic device may transform the corneal sphere center position 706 from the 3D coordinate system of the virtual camera to the 3D coordinate system of the event camera. For example, the electronic device may determine the corneal sphere center position 706 at a predetermined moment in the 3D coordinate system of the event camera, based on the corneal sphere center position 706 at the moment in the 3D coordinate system of the virtual camera.

For reference, the regressor used by the electronic device (e.g., a head-mounted device) in the example of FIG. 7 may also be trained using simulation data from an event camera on another electronic device (e.g., another head-mounted device).

FIG. 8 illustrates another example of estimating a corneal sphere center position, according to one or more embodiments.

An electronic device according to one or more embodiments may estimate the corneal sphere center position 806 at each moment through the previously-mentioned numerical solver based on the glint image position at the moment, the parameters of the event camera, the position of the light source, and the corneal sphere radius. The numerical solver may be a module for performing numerical analysis. Although it is expressed herein that a numerical solver is used for ease of description, a processor of the electronic device may alternatively perform operations according to an algorithm for numerical analysis.

In operation 811, the electronic device may obtain the glint image position. For example, the electronic device may obtain the glint image position (Gix, Giy) at each moment.

In operation 821, the electronic device may transform the glint image position at each moment to a corrected image coordinate system of the event camera according to the intrinsic parameters 701 among the parameters of the event camera. Since an eye is similar to a fisheye camera, lens distortion may occur. To correct the lens distortion described above, the glint image position may be transformed to the corrected image coordinate system of the event camera.

In operation 870, the electronic device may transform the position of the light source to the 3D coordinate system of the event camera. For example, the electronic device may transform the position of light source 703 to the 3D coordinate system of the event camera according to extrinsic parameters 802 among the parameters of the event camera.

In operation 822, the electronic device may calculate the corneal sphere center position 806 through the numerical solver. For example, the electronic device may estimate the corneal sphere center position 806 at each moment through the numerical solver based on the glint image position at the moment in the corrected image coordinate system, the position of light source 703 in the 3D coordinate system of the event camera, and the radius of corneal sphere 705. The electronic device may calculate the center of the corneal sphere through a numerical search algorithm using the known radius of the corneal sphere, based on geometric constraints between an incident ray, a reflected ray, and the direction perpendicular to the corneal sphere surface.

For example, the electronic device may calculate the 3D position coordinates of the center of the corneal sphere (e.g., the corneal sphere center) through numerical analysis, based on glints of two light sources captured by the event camera. Two light source points of a first point light source and a second point light source may be considered. The electronic device may determine a first plane corresponding to the first point light source and a second plane corresponding to the second point light source, according to a pre-corrected position of the light source (e.g., the position of the light source in the 3D coordinate system of the event camera), a corrected glint image position in the image coordinate system, and the intrinsic parameters of the camera. The first plane may be determined by an incident ray, a glint, and a reflected ray of the first point light source, and the second plane may be determined by an incident ray, a glint, and a reflected ray of the second point light source. A straight line where the first plane and the second plane intersect may be between the optic center of the camera and the corneal sphere center. The electronic device may determine a position spaced apart (by a distance k) from the optic center of the camera to the corneal sphere center along the straight line where the first plane and the second plane intersect, to be the 3D position of the corneal sphere center.

The 3D coordinates of the corneal sphere center may be expressed as a parametric representation including the distance k as the only unknown parameter. According to the law of optical reflection, the angle of incidence is equal to the angle of reflection, and a constraint equation including only the distance k, which is unknown, may be prepared. The electronic device may determine the distance k by iteratively searching for the distance k to find a numerical solution that satisfies the constraint equation. The electronic device may obtain the corneal sphere center position 806 (e.g., the 3D coordinates of the corneal sphere center) using the distance k determined based on the numerical search algorithm.

The electronic device may estimate corneal sphere center positions at of multiple moments based on the glint image position, the parameters of the event camera, the position of the light source, and the radius of the corneal sphere, through the operations described above with reference to FIG. 7 or 8. The corneal sphere center positions may be used to estimate the eye rotation center, which is described later with reference to FIGS. 8 and 9.

FIG. 9 illustrates an example of a relationship between an eye rotation center and corneal sphere center positions at K moments, according to one or more embodiments.

A corneal sphere 910 may move relative to an eye rotation center d. As an eye 920 rotates, the corneal sphere 910 may rotate about the eye rotation center d. Corneal sphere center positions c₁, c₂, and c_{K} may be considered in the estimation of the eye rotation center d. The eye rotation center position may be estimated based on the estimated corneal sphere center positions c₁, c₂, and c_{K} at of corresponding moments.

For example, the center position of a corneal sphere center rotating sphere 950 (hereinafter, the “rotating sphere”) may be estimated as the position of the eye rotation center d. Here, the rotating sphere 950 may be a sphere, the radius of which corresponds to the distance formed based on a movement trajectory of the corneal sphere center positions c₁, c₂, and c_{K} at the plurality of moments. As shown in FIG. 9, the corneal sphere center rotating sphere 950 may be a sphere, the radius of which is the distance DC formed based on the movement trajectory of a corneal sphere center 911 at moments T1 to TK.

The movement trajectory of the corneal sphere center 911 may be positioned on the surface of a 3D sphere (e.g., the corneal sphere center rotating sphere) that has the eye rotation center d as its center. The corneal sphere center rotating sphere 950 may have the eye rotation center d as its center, the radius of which is the distance between the eye rotation center d and the corneal sphere center c (e.g., c₁, c₂, and c_{K}). The distance between the eye rotation center d and the corneal sphere center c may be specified in advance as DC=∥d−c∥. For example, the distance DC may be set by a user, set to the average value of the distances between eye rotation centers d and corneal sphere centers c of the general public, or preset and/or stored as a value corrected from a default value (e.g., the average value of the general public described above) by an eye correction process for a user.

For example, the electronic device may obtain the positions (x, y, z) of the corneal sphere center 911 at moments and the radius R of the corneal sphere center rotating sphere 950 (e.g., the distance DC described above). For example, a position (x_{c}, y_{c}, z_{c}) of the center d of the corneal sphere center rotating sphere 950 may be fitted through Equation 3 to Equation 5 below. A sphere function of the corneal sphere center rotating sphere 950 may be expressed as Equation 3 below.

$${( x - {x}_{c} )}^{2} + {( y - {y}_{c} )}^{2} + {( z - {z}_{c} )}^{2} = {R}^{2} \qquad Equation 3$$

Equation 3 above may be summarized as Equation 4 below.

$$- 2 {xx}_{c} + {x}_{c}^{2} - 2 {yy}_{c} + {y}_{c}^{2} - 2 {zz}_{c} + {z}_{c}^{2} - {R}^{2} = - {x}^{2} - {y}^{2} - {z}^{2} \qquad Equation 4$$

An unknown vector p may be set as in Equation 5 below.

$$p = {[ {x}_{c} , {y}_{c} , {z}_{c} , {x}_{c}^{2} + {y}_{c}^{2} + {z}_{c}^{2} - {R}^{2} ]}^{T} \qquad Equation 5$$

Referring to Equations 4 and 5 above, Ap=b may be assumed, an i-th row of A may be Ai=[−2xi, −2yi, −2zi, 1]′, and an i-th row of b may be bi=[−xi*xi−yi*yi−zi*zi]. p may be calculated through p=(A^{T}A)⁻¹A^{T}b. When the vector p is calculated based on Equation 3 to Equation 5 described above, the center position (x_{c}, y_{c}, z_{c}) of the corneal sphere center rotating sphere 950, which is the elements of the vector p, may be obtained.

For reference, an eye optic axis at each moment may be determined based on the corneal sphere center position and the eye rotation center position. For example, an eye optic axis 931 at the moment T1 may be an axis from the center d of the corneal sphere center rotating sphere 950 toward the corneal sphere center c₁ at the moment T1. An eye optic axis 932 at the moment T2 may be an axis from the center d of the corneal sphere center rotating sphere 950 toward the corneal sphere center c₂ at the moment T2. An eye optic axis 939 at the moment TK may be an axis from the center d of the corneal sphere center rotating sphere 950 toward the corneal sphere center cₖ at the moment TK.

In addition, the electronic device may estimate the eye rotation center position based on the estimated corneal sphere center positions c₁, c₂, and c_{K} at the respective moments and the distance DC between the eye rotation center and the corneal sphere center. Here, the distance DC may be a value corrected by the eye correction process as described above, but is not limited thereto. For example, the electronic device may update the eye rotation center based on a result of examining the eye movement before fitting, to prevent a numerical degradation in fitting (e.g., an error in the eye rotation center). Updating the eye rotation center is described below with reference to FIG. 10.

FIG. 10 illustrates an example of estimating an eye rotation center position, according to one or more embodiments.

In operation 1021, an electronic device may add a corneal sphere center position at a new moment to a CSC set. The corneal sphere center position may be denoted as CSC. The CSC set may be a set including corneal sphere center positions at respective moments. The electronic device may determine the corneal sphere center position CSC at the new moment. The electronic device may add the newly determined corneal sphere center position CSC to the CSC set.

In operation 1022, the electronic device may determine whether the range of a movement trajectory corresponding to the CSC set exceeds a predetermined range threshold. The predetermined range threshold may be a predetermined range of angle. For example, the range of the movement trajectory may be expressed as the angle formed by an eye optic axis corresponding to a corneal sphere center position CSC belonging to the CSC set with another eye optic axis corresponding to another corneal sphere center position CSC belonging to the CSC set. The electronic device may determine whether the movement trajectory of the corneal sphere centers c₁ to c_{K} exceeds the predetermined range of angle (e.g., 30 degrees). For example, referring to FIG. 9, the electronic device may determine whether the maximum angle formed between the eye optical axes 931, 932, and 939 corresponding to the corneal sphere centers c₁ to c_{K} belonging to the CSC set exceeds the predetermined range of angle (e.g., the threshold angle). In the example of FIG. 9, the angle between the first eye optic axis 931 and the K-th eye optic axis 939 is shown as the maximum angle.

If the range of the movement trajectory does not exceed the predetermined range threshold, the electronic device may continue determining a corneal sphere center position CSC at a subsequent moment and adding the determined corneal sphere center position CSC to the CSC set, according to operation 1021. If the movement trajectory from c₁ to cₖ does not exceed the predetermined range of angle, the electronic device may continuously use the previously estimated eye rotation center position. The electronic device may continuously obtain a corneal sphere center position at a new moment.

In operation 1023, the electronic device may fit the center of the corneal sphere center rotating sphere 950 to the CSC set if the range of the movement trajectory exceeds the range threshold. For example, the electronic device may fit the coordinates of the center position of the corneal sphere center rotating sphere 950 based on the CSC set and the radius 1005 (e.g., the distance DC of FIG. 9) of the corneal sphere center rotating sphere previously corrected by the method described with reference to FIG. 9.

In operation 1024, the electronic device may estimate the coordinates of the eye rotation center position. The electronic device may determine the result of fitting in operations 1021, 1022, and 1023 described above to be the coordinates of the eye rotation center position. The electronic device may update the eye rotation center position.

FIG. 11 illustrates an example of determining a 3D gaze using a corneal sphere center position and an eye rotation center position, according to one or more embodiments.

An electronic device according to one or more embodiments may determine gaze information using the corneal sphere center position and the eye rotation center obtained in the examples of FIGS. 2 to 10 described above. Since operations 1111, 1112, 1121, and 1122 of obtaining the corneal sphere center position and the eye rotation center have been described in detail above, briefer descriptions of the same are provided below. The detailed description of the operations provided above with reference to FIGS. 2 to 10 are generally applicable to corresponding parts of the following operations.

In operation 1111, the electronic device may obtain event data through capturing using an event camera.

In operation 1112, the electronic device may obtain a glint label and a glint image position 1101 by processing the event data.

In operation 1121, the electronic device may estimate, for each operation cycle, a corneal sphere center position based on the glint image position 1101 of each moment, parameters 1102 of the event camera, the position 1103 of light source, and the radius 1104 of corneal sphere. The electronic device (e.g., a head-mounted device) may obtain the parameters 1102 of the event camera and the position 1103 of light source through system calibration 1191 of the electronic device. The electronic device (e.g., the head-mounted device) may obtain the radius of corneal sphere 1104 based, for example, on wearer eye parameter correction 1192.

In operation 1122, the electronic device may estimate an eye rotation center position. For example, the electronic device may estimate the eye rotation center position based on corneal sphere center positions 1106 at K moments.

As described above, in operation 110, the electronic device may determine 3D gaze-related information based on the corneal sphere center position and the eye rotation center position.

For example, in operation 1131, the electronic device may determine the optic axis of an eye. For example, the electronic device may determine the eye optic axis based on the estimated corneal sphere center position and the estimated eye rotation center position.

In operation 1132, the electronic device may determine the visual axis of the eye. For example, the electronic device may determine the visual axis of the eye to be the 3D gaze-related information (e.g., information indicating a direction corresponding to the 3D gaze) based on a Kappa angle 1105 and the determined eye optic axis. The Kappa angle 1105 may be obtained based on the wearer eye parameter correction 1192. Here, the Kappa angle 1105 may be the angle between the eye optic axis and the eye visual axis. For example, the 3D gaze-related information may be angle information between the eye visual axis (e.g., the 3D gaze) and three spatial axes in a 3D space, and is described below in Equation 7. However, the 3D gaze-related information is not limited thereto, and may vary depending on the method of expressing the 3D gaze.

Referring to FIG. 4, the optic axis of an eye (e.g., the optic axis 460 of FIG. 4) may be determined by connecting a corneal sphere center (e.g., the corneal sphere center 491-3) and an eye rotation center (e.g., the eye rotation center 499). Equation 6 below describes a unit direction vector w indicating the eye optic axis.

$$ω = \frac{d - c}{‖ d - c ‖} = [ cos ϕsinθ , sin ϕ , - cos ϕcosθ ] \qquad Equation 6$$

In Equation 6 above, c denotes the corneal sphere center, d denotes the eye rotation center, ϕ denotes the horizontal angle of the eye optic axis, and θ denotes the vertical angle of the eye optic axis. As shown in Equation 6 above, the unit direction vector ω (indicating the eye optic axis) may be determined based on the corneal sphere center c and the eye rotation center d. The three-axial vector components of the unit direction vector ω may be expressed by the horizontal angle ϕ of the eye optic axis and the vertical angle θ of the eye optic axis.

The electronic device may determine the eye visual axis (e.g., the visual axis 450 of FIG. 4) based on the Kappa angle and the horizontal angle ϕ and the vertical angle θ related to the eye optic axis. As described above, the Kappa angle 1105 may be the angle between the eye optic axis and the eye visual axis (e.g., the 3D gaze). The Kappa angle 1105 is fixed for a predetermined user and thus, may be corrected in advance. As an example, the Kappa angle 1105 may be expressed by the horizontal angle α and the vertical angle β. The angle information of the three spatial axes related to the 3D gaze may be calculated, for example, as in Equation 7 below.

$$g = [ cos ( θ + β ) sin ( θ + α ) , sin ( ϕ + β ) , - cos ( ϕ + β ) sin ( θ + α ) ] \qquad Equation 7$$

In Equation 7 above, the vector g may be a vector indicating the 3D gaze direction, and may be calculated from the angles (e.g., ϕ and θ) of the eye optic axis described above and the Kappa angle 1105 (e.g., α and β).

As described above, the electronic device according to an embodiment may perform the gaze tracking method described with reference to FIGS. 1 to 11. The electronic device may obtain glint information based on an event camera for capturing a glint signal of light emitted from a light source and reflected through the corneal sphere surface. The electronic device may estimate the corneal sphere center position and the eye rotation center position based on the glint information. The electronic device may determine 3D gaze-related information based on the corneal sphere center position and the eye rotation center position. Accordingly, the electronic device may determine the 3D gaze without using pupil information and perform gaze tracking more efficiently and economically.

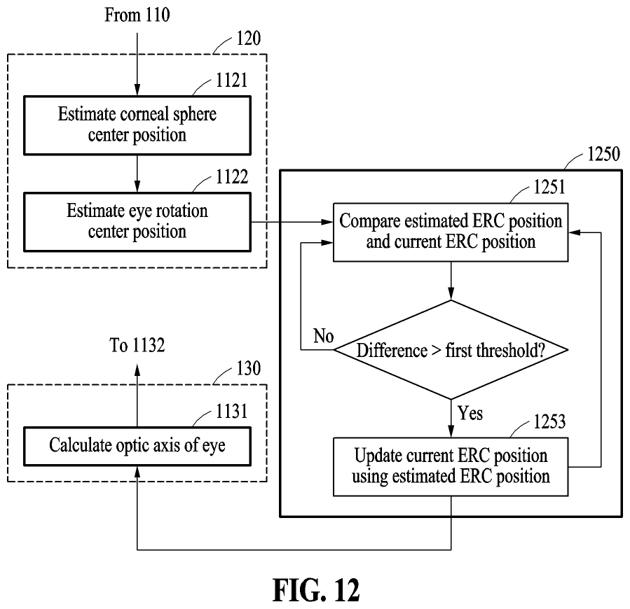

FIGS. 12 to 14 illustrate examples of sliding detection and compensation, according to one or more embodiments.

An electronic device may be implemented as a head-mounted device. During the use of the head-mounted device, device sliding may occur. Device sliding is sliding between the device and the head, which may be caused by accidental head movement between a user and the head-mounted device. Device sliding may cause errors in 3D gaze determination. After sliding occurs, a recalibration process is generally required, which requires the user to gaze at one or more points on a display. Therefore, performing recalibration for every sliding may degrade the user experience.

The electronic device according to an embodiment may detect sliding and automatically correct an error due to the sliding.

For example, the electronic device may detect sliding by detecting a change in the eye rotation center. For example, the electronic device may detect whether sliding occurs based on a change in the estimated eye rotation center position. The electronic device may determine that the electronic device (e.g., the head-mounted device) has slid/moved when the change in the estimated eye rotation center position exceeds a predetermined threshold. The electronic device may determine that sliding has not occurred when the change in the estimated eye rotation center position does not exceed the predetermined threshold.

When sliding is detected, the electronic device may correct a gaze error caused by the sliding by updating the previously determined eye rotation center position. When sliding is detected, the electronic device may update a reference eye rotation center position (e.g., the previously determined eye rotation center position) using the estimated eye rotation center position. The reference eye rotation center position may be used to determine 3D gaze-related information, which is described later. The electronic device may determine the 3D gaze-related information based on the estimated corneal sphere center position and the updated eye rotation center position.

If a change in the estimated eye rotation center position exceeds a predetermined threshold, the electronic device may update a reference eye rotation center position using the newly estimated eye rotation center position. The reference eye rotation center position may be the initially determined eye rotation center position or the eye rotation center position obtained in a previous update. For example, the electronic device (e.g., the head-mounted device) may obtain the eye rotation center position and detect sliding of the electronic device for the first time. The electronic device may update the reference eye rotation center position (e.g., the initially determined eye rotation center position) using the estimated eye rotation center position. Thereafter, when sliding occurs again in the electronic device, the electronic device may update the reference eye rotation center position using the estimated eye rotation center position.

Hereinafter, sliding detection and compensation performed based on a single eye or both eyes is described.

FIG. 12 illustrates an example of sliding detection and compensation based on a single eye, according to one or more embodiments.

In operation 1121, the electronic device may estimate a corneal sphere center position. In operation 1122, the electronic device may estimate an eye rotation center (ERC) position. Since the corneal sphere center position estimation and the eye rotation center position estimation have been described above, repeated description is omitted. According to an embodiment, the eye rotation center position estimated in operations 1121 and 1122 described above may include an estimated monocular eye rotation center position.

In operation 1250, the electronic device may update the ERC position.

For example, in operation 1251, the electronic device may compare the estimated monocular ERC position with a current reference monocular ERC position. If the difference between the estimated monocular ERC position and the current reference monocular ERC position is less than or equal to a first threshold, the electronic device may wait until a new monocular ERC position is estimated. The electronic device may perform a comparison according to operation 1251 when a new monocular ERC position is estimated.

In operation 1253, if the difference between the estimated monocular ERC position and the current reference monocular ERC position exceeds the first threshold, the electronic device may update the reference monocular ERC position using the estimated monocular ERC position.

In operation 1131, as described above, the electronic device may determine 3D gaze-related information (e.g., the optic axis of the eye) based on the estimated corneal sphere center position and the updated ERC position.

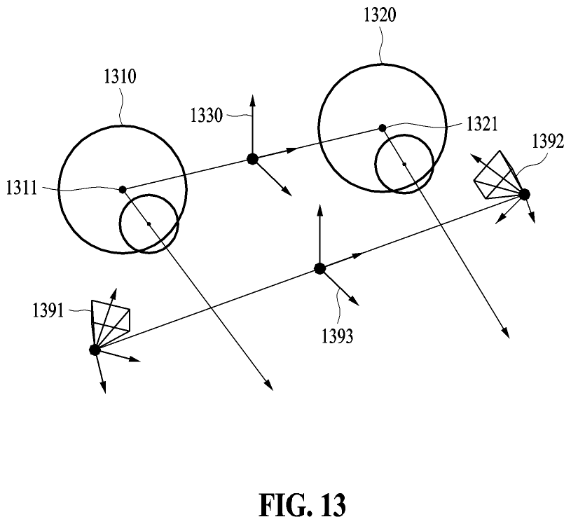

FIG. 13 illustrates an example of a relationship between the positions of both eyes in a head coordinate system and a device coordinate system. For example, it may be assumed that eye rotation centers 1311 and 1321 of the right eye 1310 and the left eye 1320 are fixed to a head coordinate system 1330 of a user. A right eye camera may be an event camera for capturing a glint reflected from the right eye 1310, and a left eye camera may be an event camera for capturing a glint reflected from the left eye 1320. A camera coordinate system 1391 of the right eye camera, a camera coordinate system 1392 of the left eye camera, and a device coordinate system 1393 may be fixed to each other. In other words, when the position and/or pose of the electronic device changes based on the world coordinate system, the camera coordinate systems 1391 and 1392 and the device coordinate system 1393 may be translated and/or rotated together based on the world coordinate system according to the change in the position and/or pose of the electronic device. Although an example in which the world coordinate system is a coordinate system different from the device coordinate system 1393 is mainly described herein, examples are not limited thereto. The device coordinate system 1393 may be set to the world coordinate system.

The electronic device according to an embodiment may update the ERC position according to the change in the pose of the device on the head.

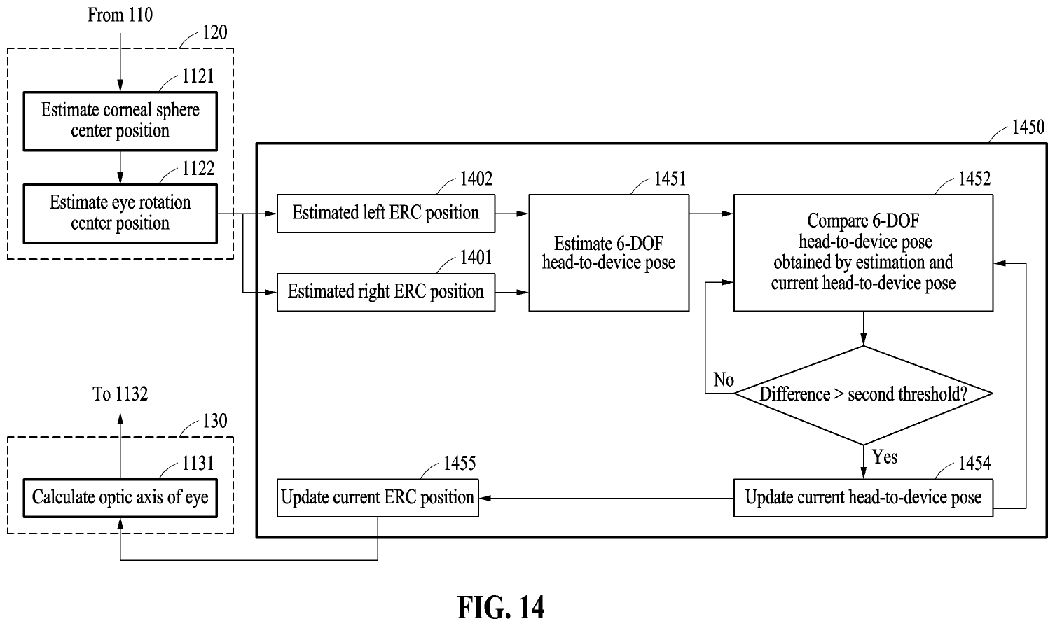

FIG. 14 illustrates an example of sliding detection and compensation based on both eyes, according to one or more embodiments.

In operation 1121, an electronic device may estimate a corneal sphere center position. In operation 1122, the electronic device may estimate an ERC position. Since both the corneal sphere center position estimation and the eye rotation center position estimation have been described above, a repeated description is omitted. The estimated eye rotation center position may include a left eye rotation center position and a right eye rotation center position.

In operation 1450, the electronic device may update ERC positions. For example, in operation 1451, the electronic device may estimate the pose of the head relative to the electronic device (e.g., a head-mounted device) based on an estimated right ERC position 1401 and an estimated left ERC position 1402. For example, the electronic device may determine a six-degree-of-freedom (DOF) head pose (e.g., the “head-to-device pose) for the head-mounted device based on the estimated left ERC position and right ERC position. Here, 6-DOF may indicate translations in three directions and rotations about three axes.

In operation 1452, the electronic device may compare the head pose with respect to the head-mounted device obtained by estimation with a current reference head pose with respect to the head-mounted device. For example, the electronic device may compare the estimated 6-DOF head-to-device pose (e.g., the estimated pose) with the current reference head-to-device pose (e.g., the reference pose). The electronic device may perform a comparison to determine whether the difference between the estimated pose and the reference pose exceeds a second threshold. The electronic device may wait until a new pose is estimated, in response to the difference between the estimated pose and the reference pose being less than or equal to the second threshold. When a new pose is estimated, the electronic device may perform a comparison according to operation 1452 described above.

In operation 1454, if the difference between the estimated pose and the current pose exceeds the second threshold, the electronic device may update the current reference pose using the estimated pose (e.g., the 6-DOF head-to-device pose). The updated reference pose may be used to update the ERC positions of both eyes.

In operation 1455, the electronic device may update the current reference left ERC position and the current reference right ERC position based on the updated pose. Accordingly, the electronic device may determine the ERC positions (e.g., the right ERC position and the left ERC position) updated based on the head-to-device pose (e.g., the reference pose) updated according to a change in the geometric relationship between the device coordinate system and the head coordinate system (e.g., the change in pose). The updated reference right ERC position and reference left ERC position may be used to estimate 3D gaze-related information. The 3D gaze may be used to determine a physical point or object being looked at by the user.

In operation 1131, the electronic device may finally determine the 3D gaze-related information according to the estimated corneal sphere center position and the updated ERC position. For example, the electronic device may calculate the eye optic axis based on the estimated corneal sphere center position and the updated ERC position. In operation 1132, the electronic device may determine the 3D gaze-related information based on the eye optic axis and a Kappa angle.

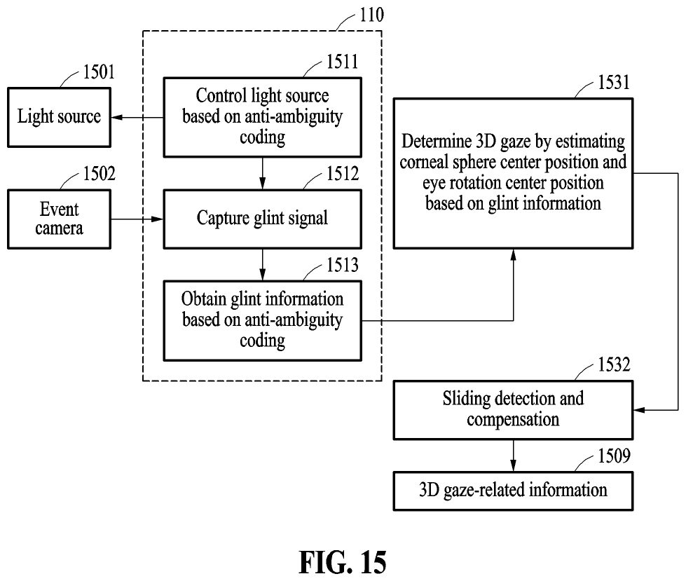

FIG. 15 illustrates an example of a method for gaze tracking, according to one or more embodiments.

In operation 1511, an electronic device may control a light source 1501 based on anti-ambiguity coding. The light source 1501 may be coded using any of the anti-ambiguity coding methods mentioned above. The electronic device may control the light source 1501 using a coded bit sequence (e.g., a light source code set), where each light source encodes its own unique bit sequence through its light emission pattern.

In operation 1512, an event camera 1502 of the electronic device may capture a glint signal. In operation 1513, the electronic device may obtain glint information based on anti-ambiguity coding. In operation 1531, the electronic device may determine 3D gaze-related information 1509 by estimating a corneal sphere center position and an eye rotation center position based on the glint information. In operation 1532, the electronic device may perform sliding detection and compensation. The electronic device may more accurately determine the 3D gaze-related information 1509. Since the light source control, glint information obtainment, corneal sphere center position and eye rotation center position estimation for 3D gaze determination, and sliding detection and compensation have been described above, a repeated description will be omitted here.

The gaze tracking method according to an embodiment and examples thereof have been described above with reference to FIGS. 1 to 15 in combination. However, not all the operations described with reference to FIGS. 1 to 15 are to be performed in the order described, and depending on the design, some operations may be omitted, the order of operations may be changed, or operations described elsewhere in this specification may be additionally performed sequentially and/or in parallel. For example, operation 1532 may be an operation that is selectively performed to more accurately determine the 3D gaze-related information.

The electronic device according to an embodiment may determine the 3D gaze-related information without using pupil information, thereby performing gaze tracking more efficiently and at a lower cost. The electronic device may improve the accuracy of glint information obtained through the anti-ambiguity coding method described above and the accuracy of determining the 3D gaze-related information. The electronic device may further improve the accuracy of determining the 3D gaze-related information by performing the sliding detection and compensation described above, thereby improving user experience.

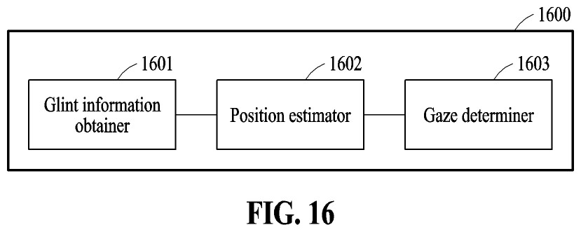

FIG. 16 illustrates an example of an electronic device for gaze tracking, according to one or more embodiments.

An electronic device according to an embodiment may also be referred to as a “gaze tracking device 1600”. The gaze tracking device 1600 may include a glint information obtainer 1601, a position estimator 1602, and a gaze determiner 1603.

The glint information obtainer 1601 may obtain glint information. The glint information may be obtained based on an event camera for capturing a glint signal of light emitted from a light source and reflected through the corneal sphere surface, as described above.

The position estimator 1602 may estimate a corneal sphere center position and an eye rotation center position based on the glint information.

The gaze determiner 1603 may determine 3D gaze-related information based on the corneal sphere center position and the eye rotation center position.

The gaze tracking device 1600 may perform the gaze tracking method described with reference to FIGS. 1 to 15. For example, the glint information obtainer 1601 may perform operation 110 of FIG. 1, the position estimator 1602 may perform operation 120, and the gaze determiner 1603 may perform operation 130. For details on any operation related to the task performed by each component of FIG. 16, reference may be made to the description of the corresponding operation in FIGS. 1 to 15. A repeated description will be omitted here.

In addition, it is described that each component performs corresponding processing in describing the gaze tracking device 1600, but examples are not limited thereto. The processing performed by each component may be performed without separating or clearly dividing the components by the gaze tracking device 1600. In addition, the gaze tracking device 1600 may further include other components, such as a storage device.

FIG. 17 illustrates an example of an electronic device, according to one or more embodiments.

An electronic device 1700 according to an embodiment may be a head-mounted device. The head-mounted device including a display may also be referred to as a head-mounted display (HMD) device. The electronic device 1700 may include an event camera 1710, a light source array 1720, a processor 1730, and a memory 1740.

The event camera 1710 may generate event data based on sensing an event signal. As described above, the event data may include glint information.

The light source array 1720 may include a plurality of light sources. The plurality of light sources may be, for example, LED light sources. As described above, the plurality of light sources may be repeatedly turned on and off according to respectively assigned unique light source codes in a light source code set. Light emitted from each of the plurality of light sources may be reflected by the cornea of an eye 1791 and reach the event camera 1710. FIG. 17 conceptually shows an example optical path 1780 corresponding to a predetermined light source 1721.

An example of the plurality of light sources of the light source array 1720 being disposed in a circle along a frame of the electronic device 1700 having an eyewear-type housing is shown. The event camera 1710 may be disposed on a portion of the frame of the electronic device 1700. The light source array 1720 and the event camera 1710 may be disposed toward the face (e.g., the eyes) of a user 1790, when the electronic device 1700 is mounted by the user 1790. However, the arrangement of the event camera 1710 and the plurality of light sources within the electronic device 1700 is not limited thereto and may vary depending on the design.

The processor 1730 may obtain a glint label and a glint image position by processing the event data. The processor 1730 may estimate a corneal sphere center position and an eye rotation center position from the glint image position. The processor 1730 may determine 3D gaze-related information based on the estimated corneal sphere center position and the estimated eye rotation center position. The 3D gaze tracking method performed by the processor 1730 is not limited thereto. The processor 1730 may perform the operations according to the methods described above with reference to FIGS. 1 to 16. The processor 1730 may include a central processing unit (CPU), a graphics processing unit (GPU), a programmable logic device, a dedicated processor system, a microcontroller, or a microprocessor. As a non-limiting example, the processor 1730 may further include an analog processor, a digital processor, a microprocessor, a multicore processor, a processor array, or a network processor.

The memory 1740 may store computer-executable instructions. The computer-executable instructions, when executed by the processor 1730, may cause the processor 1730 to execute a method for gaze tracking according to an embodiment. The memory 1740 may be integrated with the processor 1730 by arranging, for example, random-access memory (RAM) or flash memory 1740 in an integrated circuit microprocessor 1730. In addition, the memory 1740 may include an independent device, such as an external disk drive, a storage array, or other storage devices that may be used by any database system. The memory 1740 and the processor 1730 may be operatively coupled or communicate through an input/output (I/O) port or a network connection, so that the processor 1730 may read files stored in the memory 1740.

The processor 1730 may execute the instructions or code stored in the memory 1740, and the memory 1740 may further store data. The instructions and data may also be transmitted and received over a network through a network interface that can use any known transmission protocol. A network interface device may utilize any known transmission protocols.

In addition, the electronic device 1700 may further include a video display (e.g., a liquid crystal display (LCD)) and a user interaction interface (e.g., a keyboard, a mouse, or a touch input device). All the components of the electronic device 1700 may be connected to each other through a bus and/or a network.

Although an example in which the electronic device 1700 is a head-mounted device is mainly described herein, examples are not limited thereto. For example, the electronic device 1700 may be a personal computer (PC), a tablet device, a personal digital assistant (PDA), a smartphone, or other devices for executing the instruction set mentioned above. Here, the electronic device 1700 may not need to be a single electronic device 1700, and may be a device or assembly of circuits capable of executing the instructions (or the instruction set) alone or jointly. The electronic device 1700 may also be part of an integrated control system or system manager, or may be configured as a portable electronic device 1700 for interfacing locally or remotely (e.g., via wireless transmission). For example, the electronic device 1700 may include a processor 1730 and a memory 1740, and a separate device may include an event camera 1710 and a light source array 1720. The separate device may be mounted on the head of the user and generate event data using the light source array 1720 and the event camera 1710. The separate device may transmit the generated event data to the electronic device 1700 using a wire and/or wirelessly. The electronic device 1700 may receive the event data in real time from the separate device. The electronic device 1700 may determine 3D gaze-related information using the event data. The electronic device 1700 may transmit the determined 3D gaze-related information to the separate device using a wire and/or wirelessly. The separate device may further include a display. The separate device may provide (e.g., output) information based on the 3D gaze-related information (e.g., an image rendered based on the 3D gaze-related information).

A method and device for gaze tracking according to an embodiment may obtain glint information by capturing a glint signal of light emitted from a light source and reflected from the corneal surface using the event camera 1710, estimate a corneal sphere center position and an eye rotation center position based on the glint information, and determine 3D gaze-related information based on the corneal sphere center position and the eye rotation center position, thereby determining the 3D gaze-related information without using pupil information and thus, implementing gaze tracking more effectively at a lower cost.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The computing apparatuses, the electronic devices, the processors, the memories, the image sensors, the displays, the information output system and hardware, the storage devices, and other apparatuses, devices, units, modules, and components described herein with respect to FIGS. 1-17 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-17 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A gaze tracking method, performed by an electronic device, comprising:
obtaining glint information based on capturing, using an event camera, a glint signal corresponding to light emitted from light sources, wherein each light source operates according to a corresponding unique light source code of a light source code set;
estimating a corneal sphere center position and an eye rotation center position based on the glint information; and
determining three-dimensional (3D) gaze-related information based on the corneal sphere center position and the eye rotation center position.

2. The gaze tracking method of claim 1, wherein the obtaining of the glint information comprises:
obtaining event data by capturing the glint signal using the event camera; and
obtaining one or more pieces of glint information by processing the event data, and wherein
the one or more pieces of glint information comprise a glint image position, according to an image coordinate system of the event camera, of a glint corresponding to one or more of the light sources.

3. The gaze tracking method of claim 2, wherein the obtaining of the one or more pieces of glint information comprises:
identifying one or more binary codes respectively corresponding to one or more glints from a result of analyzing the event data;
determining a binary code matching a key code of the light source code set from the identified one or more binary codes;
determining a time corresponding to a start bit of a bit sequence of the determined binary code; and
obtaining a glint image position of a glint corresponding to a glint label mapped to the key code of the light source code set.

4. The gaze tracking method of claim 1, wherein in a light source array comprising the light sources, a key bit of a light source corresponding to a key code of the light source code set and a key bit of another light source adjacent to the light source are different.

5. The gaze tracking method of claim 1, wherein in a light source array comprising the light sources, two or more light sources respectively corresponding to key codes of the light source code set are spaced apart by a predetermined distance.

6. The gaze tracking method of claim 1, wherein
the light sources are arranged in a circle on a same plane, and
a distance between two light sources corresponding to respective key codes of the light source code set, among the light sources, is a diameter of the circle.

7. The gaze tracking method of claim 1, wherein the estimating comprises:
estimating a corneal sphere center position at different moments based on the glint information of each moment; and
estimating the eye rotation center position based on a distance between a reference eye rotation center and the corneal sphere center and based on estimated corneal sphere center positions at respective of the moments.

8. The gaze tracking method of claim 7, wherein
the glint information comprises a glint image position,
the glint image position is a position of a glint from a corresponding light source among the light sources in an image coordinate system of the event camera, and
the estimating comprises estimating a corneal sphere center position at each of the moments using a regressor based on the glint image position at the moment.

9. The gaze tracking method of claim 8, wherein the estimating of the corneal sphere center position at each moment comprises:
transforming the glint image position at each moment from the image coordinate system of the event camera to an image coordinate system of a virtual camera, based on intrinsic parameters among parameters of the event camera;
estimating the corneal sphere center position at the moment in a 3D coordinate system of the virtual camera through the regressor, from the glint image position at the corresponding moment; and
transforming the corneal sphere center position at the moment from the 3D coordinate system of the virtual camera to a 3D coordinate system of the event camera.

10. The gaze tracking method of claim 7, wherein
the glint information comprises a glint image position,
the glint image position is a position of a glint from a corresponding light source among the light sources in an image coordinate system of the event camera, and
the estimating comprises estimating a corneal sphere center position at each moment through a numerical solver based on the glint image position at the moment, the parameters of the event camera, the position of the light source, and a radius of the corneal sphere.

11. The gaze tracking method of claim 10, wherein the estimating of the corneal sphere center position at each moment comprises:
transforming the glint image position at each moment to a corrected image coordinate system of the event camera, based on intrinsic parameters among parameters of the event camera;
transforming the position of the light source to a 3D coordinate system of the event camera, based on extrinsic parameters among the parameters of the event camera; and
estimating a corneal sphere center position at each moment through the numerical solver based on the glint image position at the corresponding moment in the corrected image coordinate system, a position of the light source in the 3D coordinate system of the event camera, and the radius of the corneal sphere.

12. The gaze tracking method of claim 7, wherein the estimating of the eye rotation center position comprises estimating the eye rotation center position to be a position of a center of a rotating sphere determined based on a movement trajectory of the corneal sphere center positions at the moments.

13. The gaze tracking method of claim 7, wherein the estimating of the eye rotation center position comprises updating the eye rotation center position if a range of the movement trajectory of the corneal sphere center positions at the plurality of moments exceeds a predetermined range threshold.

14. The gaze tracking method of claim 1, wherein
the electronic device is a head-mounted device,
the gaze tracking method further comprises updating a reference eye rotation center position using the estimated eye rotation center position, when movement of the head-mounted device relative to a wearer's head is detected, and
the determining of the 3D gaze-related information comprises determining 3D gaze-related information based on the corneal sphere center position and the updated eye rotation center position.

15. The gaze tracking method of claim 14, wherein the updating comprises updating the reference eye rotation center position using the estimated eye rotation center position, when a change in the estimated eye rotation center position exceeds a predetermined threshold.

16. The gaze tracking method of claim 15, wherein the updating of the reference eye rotation center position comprises:
comparing an estimated monocular eye rotation center position and a current reference monocular eye rotation center position; and
updating the reference monocular eye rotation center position using the estimated monocular eye rotation center position, when a difference between the estimated monocular eye rotation center position and the reference monocular eye rotation center position exceeds a first threshold.

17. The gaze tracking method of claim 15, wherein the updating of the reference eye rotation center position comprises:
estimating a head pose with respect to the electronic device based on an estimated left eye rotation center position and an estimated right eye rotation center position;
comparing the estimated head pose with a current reference head pose; and
updating the reference head pose with the estimated head pose and updating the left eye rotation center position and the right eye rotation center position based on the updated head pose, when a difference between the estimated head pose and the reference head pose exceeds a second threshold.

18. The gaze tracking method of claim 1, wherein the determining of the 3D gaze-related information comprises:
determining an eye optic axis based on the corneal sphere center position and the eye rotation center position; and
determining an eye visual axis as the 3D gaze-related information based on the eye optic axis and a Kappa angle between the eye optic axis and the eye visual axis.

19. A method comprising:
emitting, onto an eyeball, light from light sources, wherein each light source emits light with a respective unique emission pattern of varying light intensity;
detecting, asynchronously from the emitting of the light from the light sources, glints on the eyeball from the respective light sources, wherein each glint has an intensity pattern corresponding to the emission pattern of the light source from which it originates;
determining, among the glints, a key glint based on the intensity pattern of the key glint; and
based on the determining of the key glint, determining which of the other glints come from which of the light sources.

20. An electronic device comprising:
light sources, each light source operating according to a light source code of a light source code set, each light source code being unique from each other light source code;
an event camera configured to capture a glint signal corresponding to light emitted from the light sources;
one or more processors; and
a memory storing computer-executable instructions configured to cause the one or more processors to:
obtain glint information based on capturing using the event camera,
estimate a corneal sphere center position and an eye rotation center position based on the glint information, and
determine three-dimensional (3D) gaze-related information based on the corneal sphere center position and the eye rotation center position.
